(19) United States
(12) Patent Application Publication
(10) Pub. No.: US 2014/0297399 A1
(43) Pub. Date: Oct. 2, 2014

(54) SYSTEM AND METHOD FOR PROVIDING SOCIAL MEDIA MARKETING PERFORMANCE AND FEEDBACK

(71) Applicant: MarketBridge Inc., Bethesda, MD (US)

(72) Inventors: Lane Douglas, Bethesda, MD (US); Michael Kelleher, Bethesda, MD (US)

(73) Assignee: MarketBridge Inc., Bethesda, MD (US)

(21) Appl. No.: 14/078,585

(22) Filed: Nov. 13, 2013

Related U.S. Application Data
(60) Provisional application No. 61/726,160, filed on Nov. 14, 2012.

(51) Int. Cl. G06Q 30/02

(52) U.S. Cl. CPC G06Q 30/0243
USPC 705/14.42

(57) ABSTRACT

Provided are a system and a method that compares a client's brand to competitors' brands using normalized reference benchmarks. The normalized reference benchmarks are produced utilizing social media metrics. The system and method also provide constructive feedback on how the client can obtain a higher normalized reference benchmark. Also provided is a computer program code that implements the method steps.

### FIELD OF THE INVENTION

The invention relates to a system and method for providing a client with normalized reference benchmarks comparing the client's brand to competitors' brands, and for providing constructive feedback on how to obtain a higher normalized reference benchmark. The invention also relates to a computer program product comprising code for executing the method steps.

### BACKGROUND OF THE INVENTION

Marketing is now well known. The following internet websites describe firms providing marketing information based on information gleaned from social media websites:
Dachis Group (http://www.socialbusinessindex.com)
Echo Rank (http://echorank.theechosystem.com/echo-rank/?)
Social IQ Networks (http://socialiqnetworks.com)
Social Bakers (http://www.socialbakers.com/)
RSM Index (http://www.rsmindex.com/)
imply Measured (http://simplymeasured.com/)
Relate IQ (https://www.relateiq.com/)
Adaptly (Momentum) (http://adaptly.com/momentum)
comScore Social Essentials (http://www.comscore.com/Products_Services/Product_Index/Social_Essentials)
Data Sift (http://datasift.com/)
Klout (http://klout.com)
Kred (http://kred.com)
Peer Index (http://peerindex.com)

However, the information provided by these prior art methods is lacking in several areas, including feedback on how to improve brand marketing compared to competitors' brands, normalized reference benchmarks for different areas of social media marketing so that comparisons can easily be conducted, and other shortfalls.

### SUMMARY OF THE INVENTION

The present invention includes a novel bench marking method and system that provides a client with a brand score for their overall social media marketing performance in social media as well as a rank against a set of competitors' brands to provide constructive feedback so that improvements in social media marketing effectiveness and efficiency can be achieved. The present invention comprises custom categories (marketing performance metrics) that encompass a broad range of potential effectiveness in social media, which are built by integrating and weighting different social media metrics in a novel method. The present invention utilizes social media metrics that are publicly available through the various social networks and/or through purchased, third-party platforms. Additionally, the social media metrics are extracted from the social media in such a manner that both owned networks (a brand's own social media pages and identities) and the broader social sphere (news media, forums, blogs, comments, videos, ecommerce) are utilized.

The present invention integrates core social media metrics. Each of the major social networks have their own metrics to score various activities. For example, Facebook defines followers as “likes,” while Twitter defines them as “followers.” Both social media metrics, however, stand for the same thing, namely, the voluntary association of a person with a social account allowing the person to see posts and content from the brand inside their respective “stream” or “wall.”

Brands have a presence on multiple social networks. The present invention is the first to utilize these various forms of loyal communities to provide normalized values, such as integrated metrics. The prior art systems fail to provide such an integrated metric. For example, a preferred embodiment of the invention provides nine marketing performance metrics that utilize different portions of social media metrics extracted from the major social networks to provide normalized reference benchmarks.

An objective of the present invention is to provide a relevant, competitive scale that allows the client's brand score to be actionable, i.e. provide relevant feedback. The prior art scoring systems available simply provide the client with an outlook on their own social channels. In contrast, the present invention extracts social media metrics from social media and manipulates the data in such a manner that the results are presented as objective competitive benchmarks to provide actionable feedback. For example, “highs and lows” for each marketing performance metric can be set by the competitors' brands so that the scores are relevant to the client's brand.

In contrast, prior art influencer systems have the client on the same scale as personal celebrities and massive corporations. For example, if the client's score is a 62, and that of the celebrity Tom Cruise is 95, there is no relevant information provided to the client to provide effective changes that can be implemented into the client's marketing.

The present invention is the first system that is capable of providing the client with the highest score per category that is reachable and actionable by that client. In addition, feedback can be provided so that the client now understands how to obtain the highest obtainable score.

The present invention can provide scoring that accounts for influence across the entire social media arena as well as owned and branded channels. The present invention does not just re-hash or re-present the analytics that the client can already obtain from their own social media insights. As previously mentioned, the present invention can integrate all social networks and then weight the scores to provide a comprehensive analysis.

The present invention goes a step further than where the prior art methods stop. The present invention can search the entire social media space for mentions and discussions around the client's brand and integrate that data as well. Thus, when the client's score is calculated to provide “Potential Reach,” the present invention does not merely include the extended community of the immediate fans and followers of the client's brand, rather the calculation includes those engaging the client's industry and brand beyond the immediate reach and are still accessible.

The present invention can provide a client with analyst insight. The marketing performance metrics are not limited to simply relating to social media performance. The marketing performance metrics can be constructed to translate over to business capabilities and return on investment forecasting. The results calculated by the system and method can be used to provide actionable strategies intended to drive revenue and reduce costs.

The above objectives and other objectives are obtained by a method of providing a brand benchmark of marketing performance for a client brand comprising:
defining an industry arena or vertical;
providing a client brand within the defined industry arena or vertical;
providing a group of competing brands within the defined industry arena or vertical;
providing brand keyword groups for the client brand and each competing brand to capture variations of the client brand name and variations of the competing brand names;
providing industry keyword groups to provide a sampling of discussions relating to the client brand and competing brands;
defining a plurality of marketing performance metrics;
extracting social media metrics from a plurality of social media sites using the brand keywords and industry keywords;
associating the social media metrics with the marketing performance metrics;
calculating benchmarks for each marketing performance metric for each brand, wherein a first marketing performance metric utilizing a first social media metric and a second marketing performance metric utilizing a second social media metric;
normalizing the marketing performance metrics so that the marketing performance metric benchmarks can relate to one another;
calculating an overall benchmark for each brand based on the marketing performance metric benchmarks; and
outputting at least one of the benchmarks.

The above objectives and other objectives are also obtained by a system for providing a brand benchmark of marketing performance for a client brand comprising:
a server being in communication with or comprising at least one non-volatile memory;
a user interface device in communication with the server; and
computer program code configured to store in the non-volatile memory a client brand within a defined industry arena or vertical, a group of competing brands within the defined industry arena or vertical, brand keyword groups for the client brand and each competing brand to capture variations of the client brand name and variations of the competing brand names, industry keyword groups to provide a sampling of discussions relating to the client brand and competing brands, and a plurality of marketing performance metrics, wherein the code being configured to extract social media metrics from a plurality of social media sites using the brand keywords and industry keywords, associate the social media metrics with the marketing performance metrics, calculate benchmarks for each marketing performance metric for each brand, wherein a first marketing performance metric utilizing a first social media metric and a second marketing performance metric utilizing a second social media metric, normalize the marketing performance metrics so that the marketing performance metric benchmarks can relate to one another, calculate an overall benchmark for each brand based on the marketing performance metric benchmarks, and output at least one of the benchmarks.

The above objectives and other objectives can further be obtained by a computer program product comprising a computer usable medium having a computer readable program code embodied therein, wherein the computer readable program code being constructed to be executed to implement a method of providing a brand benchmark of marketing performance for a client brand comprising:
defining an industry arena or vertical;
providing a client brand within the defined industry arena or vertical;
providing a group of competing brands within the defined industry arena or vertical;
providing brand keyword groups for the client brand and each competing brand to capture variations of the client brand name and variations of the competing brand names;
providing industry keyword groups to provide a sampling of discussions relating to the client brand and competing brands;
defining a plurality of marketing performance metrics;
extracting social media metrics from a plurality of social media sites using the brand keywords and industry keywords;
associating the social media metrics with the marketing performance metrics;
calculating benchmarks for each marketing performance metric for each brand, wherein a first marketing performance metric utilizing a first social media metric and a second marketing performance metric utilizing a second social media metric;
normalizing the marketing performance metrics so that the marketing performance metric benchmarks can relate to one another;
calculating an overall benchmark for each brand based on the marketing performance metric benchmarks; and
outputting at least one of the benchmarks.

### BRIEF DESCRIPTION OF THE DRAWINGS

FIG. 1 is a representation of an embodiment of the system of the invention;

FIG. 2 is a flowchart of an embodiment of the invention;

FIGS. 3A-3D is a screenshot of an exemplary brand and competitors' keyword and URL entry;

FIGS. 4A-4C is a screenshot of exemplary marketing performance metrics and social network metric entry screen;

FIGS. 5A-5F is a screenshot of an exemplary scale setting and normalization entry;

FIGS. 6A-6C is a screenshot of an exemplary weighting entry;

FIGS. 7A-7B is a screenshot of an exemplary marketing performance metric weighting entry;

FIGS. 8A-8F is a screenshot of an exemplary final scoring and graphing generator;

FIGS. 9A-9F is a screenshot showing exemplary calculations of performance; and

FIGS. 10A-10C is a screenshot showing exemplary graphs of performance.

### DETAILED DESCRIPTION OF THE INVENTION

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention can be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

The method, system and computer product will now be explained with reference to the attached non-limiting drawings. The operations described in the Figs. and herein can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

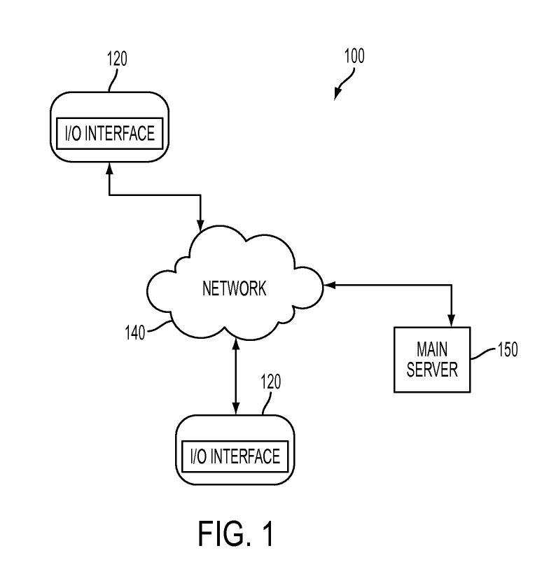

FIG. 1 illustrates a system 100 according to an embodiment of the invention. Various networks 140 may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, OSI, Ethernet, WAP, IEEE 802.11, Bluetooth, Zigbee, IrDa or any other desired protocol. Furthermore, components of the system may communicate through a combination of wired or wireless paths.

The system 100 can be accessed via any user interface device 120 that is capable of connecting to the main server 150 via the network 140 or directly to the server 150 if desired. The user interface device 120 preferably comprises a keyboard or touch screen display to input information.

An exemplary user interface device 120 contains a web browser or similar program, allowing in some embodiments for a secure SSL connection, and able to display HTML and CSS. This includes user interface devices 120 such as tablets, iPads, Mac OS computers, Windows computers, e-readers, and mobile user devices such as the iPhone, Android, and Windows Phone. The user interface devices 120 can connect to the server via the internet and/or wirelessly, such as through a mobile telephone network 140, and/or any other suitable medium. User interface devices 120 are preferably able to communicate to the main server 150 so that content can be started on one user interface device 120 and later continued on a separate user interface device 120.

The main server 150 described herein can include one or more computer systems directly connected to one another and/or connected over the network 140. Each computer system can include a processor, tangible, non-volatile memory, user input and user output mechanisms, a network interface, and executable program code (software) comprising computer executable instructions stored in non-transitory tangible memory that executes to control the operation of the main server 150. Similarly, the processors functional components formed of one or more modules of program code executing on one or more computers. Various commercially available computer systems and operating system software can be used to implement the hardware and software. The components of each server can be co-located or distributed. In addition, all or portions of the same software and/or hardware can be used to implement two or more of the functional servers (or processors) shown. The main server 150 can run any desired operating system, such as Windows, Mac OS X, Solaris or any other server based operating systems. Other embodiments can include different functional components. In addition, the present invention is not limited to a particular environment or main server 150 configuration. The main server 150 can be a cloud based computer system.

The main server 150 preferably includes a web server and a query processing unit. The web server receives the user requests and sends it to the query processing unit. The query processing unit processes the request and responds back to the user interface device 120 via the web server. The query processing unit fetches data from the database server if additional information is needed for processing the request.

The main server 150 can include a plurality of individual computer systems directly connected and/or connected over network 140. Software program modules and data stored in the non-volatile memory of the main server 150 may be arranged in logical collections of related information on a plurality of computer systems having associated non-volatile memories. The main server 150 can comprise the non-volatile memory or the main server 150 can be in communication with the non-volatile memory storing the database.

The software (computer program code) and data may be stored in the non-volatile memory using any data structures known in the art including files, arrays, linked lists, relational database tables and the like. A particularly preferred software is Microsoft Excel or equivalent. The stored data can include, for example, client information, brand information, search keywords, marketing performance metrics, social media metrics, benchmark scores, overall marketing performance scores, or any other desired information.

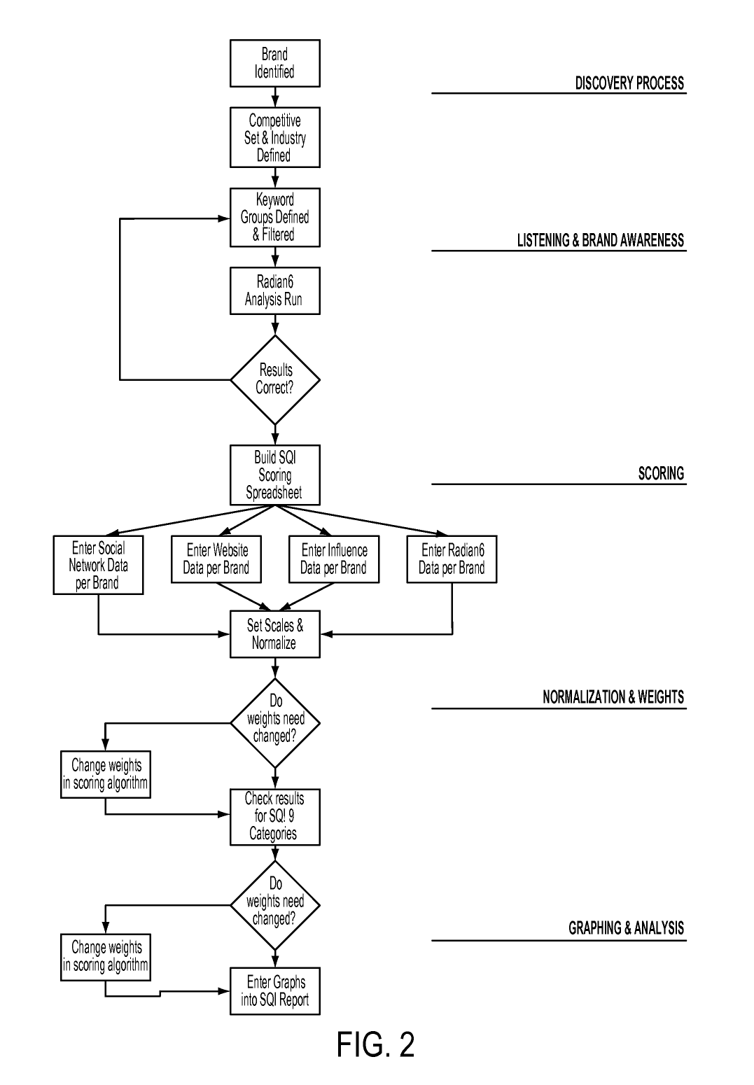

An embodiment of the method illustrated in the flow chart of FIG. 2 will now be described. The order of the steps described herein and/or recited in the attached claims can be changed as desired unless otherwise stated. This non-limiting embodiment will be described using Excel.

An industry arena or vertical is defined. Typically the client defines the majority of the industry arena or vertical.

A client's specific brand within the defined industry arena or vertical is inputted to the server 150 and stored in the non-volatile memory using the user interface device 120. The term “brand” includes reference to a single product, a product line, or an entire company's products. For example, the term brand can refer to all Dell products (as a corporate whole), the product line of Dell laptop computers, or a single Dell product, as desired by the client. Use of the term brand herein includes both the client's and competitors' brands unless otherwise stated.

A plurality of competitors' brands within the defined industry arena or vertical is defined and inputted to the server 150 and stored in the non-volatile memory using the user interface 120. Preferably, at least five competitors' brands are defined and inputted to the server 150.

Brand keyword groups for the specific brand and each competing brand to capture variations of the specific brand name and variations of the competing brand names are defined and inputted into the server 150 and stored in the non-volatile memory using the user interface device 120. For example, the client brand “Starbucks” can also have in the keyword group “SBux,” “Starbucks Coffee,” and “the green mermaid” to ensure that all references to the client's brand in social discussions can be captured.

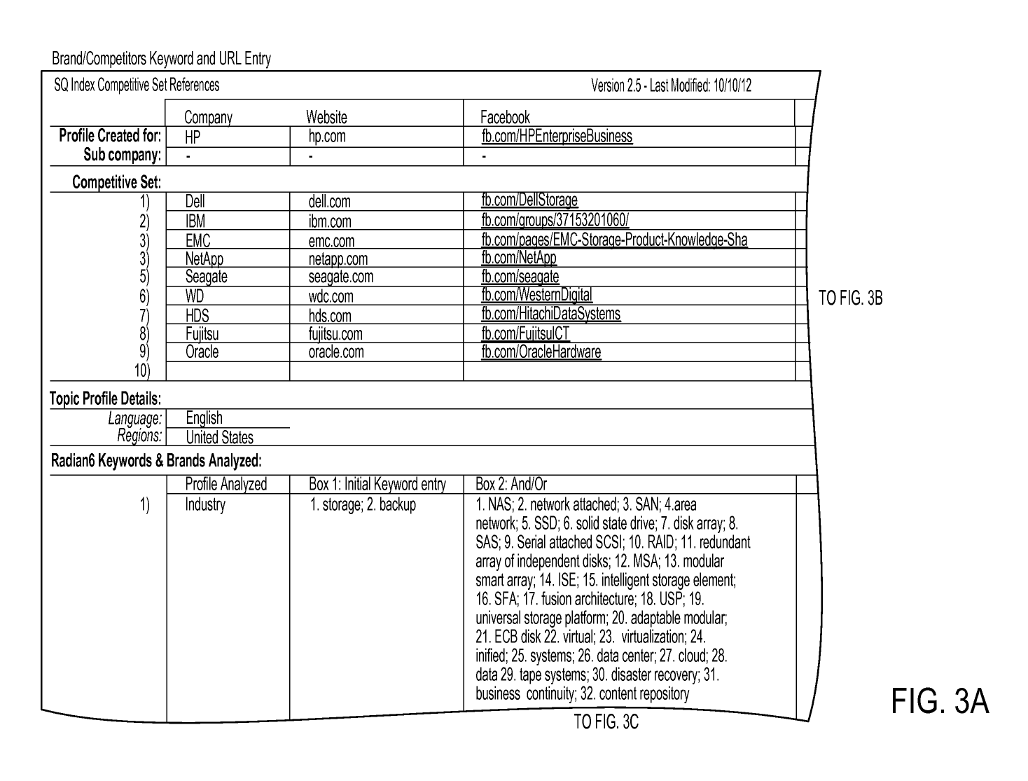

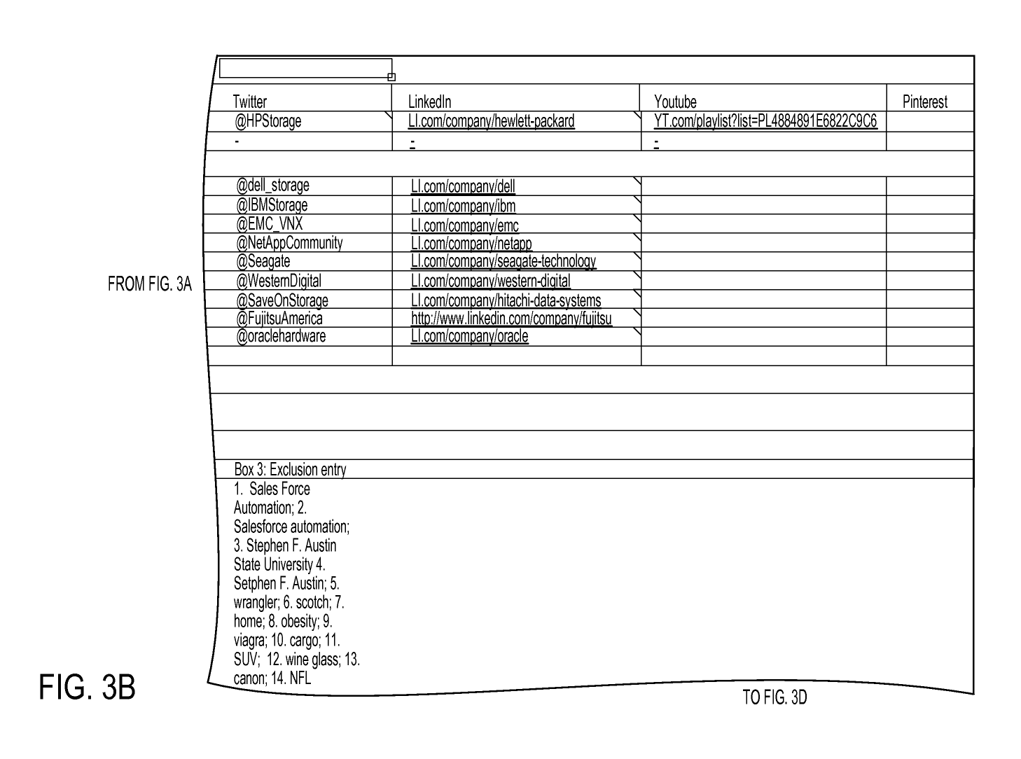

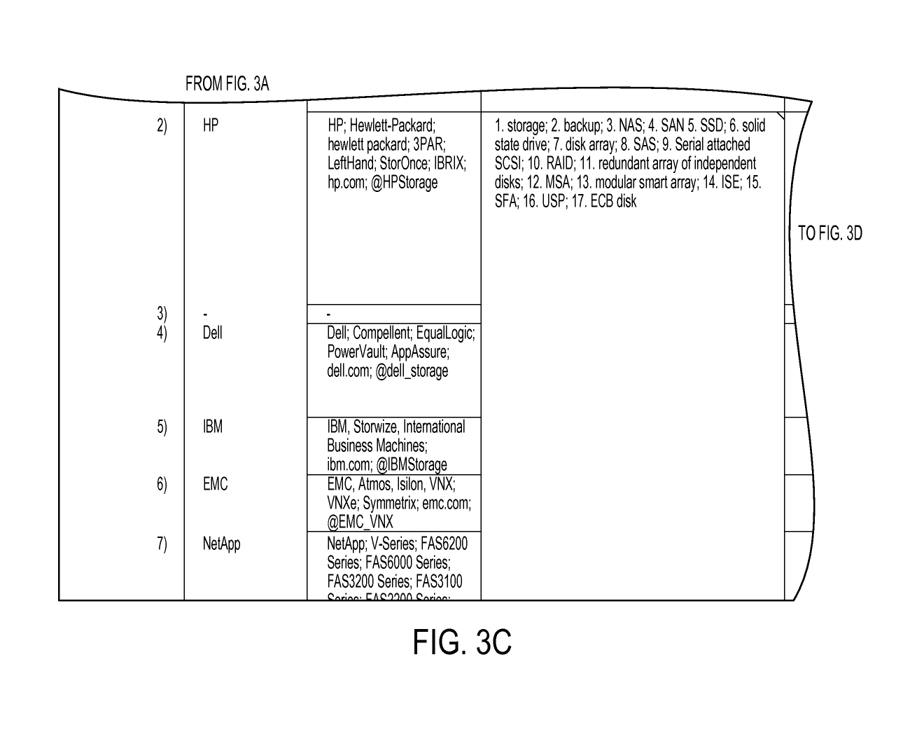

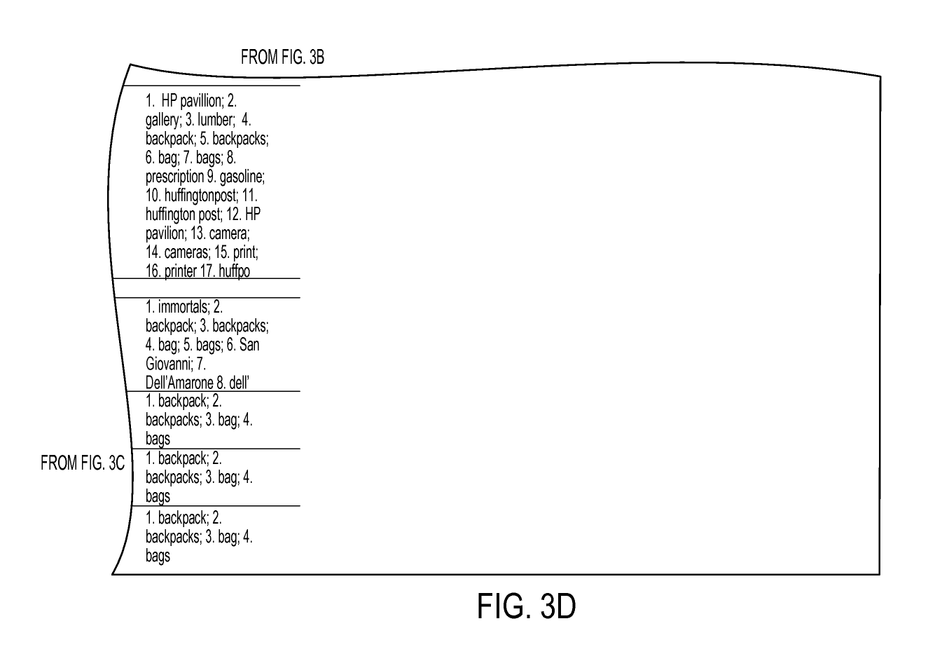

Industry keyword groups to provide a sampling of discussions relating to the specific brand and competing brands are defined and inputted into the server 150 using the user interface device 120. Preferably, the keywords are defined to ensure a sampling of the discussions is being captured to analyze a focused vertical, while excluding non-desired information. As an example, if the client brand is the “orange juice industry,” “OJ” would have to be grouped and filtered to ensure that mentions of “OJ” in relation to the drink were captured while discussions surrounding “OJ Simpson” were being excluded. An example is illustrated in the screenshot of FIGS. 3A-3D.

For each brand, the following information is also preferably entered into the server 150:
Main website URL
Official Facebook Page URL
Official Twitter username
Official LinkedIn Company Page address
Official Company YouTube channel.
An example is shown in the screenshot of FIGS. 3A-3D.

The accuracy of the keywords can optionally be verified by conducting test searches using the keywords, for example by searching Radian6. The keywords can be modified as desired based on the testing searches. For example, if the amount of undesired information extracted by the keywords is too large, the keywords can be modified to reduce the amount of undesired information. The testing and modifying of the keywords can be conducted as many times as desired.

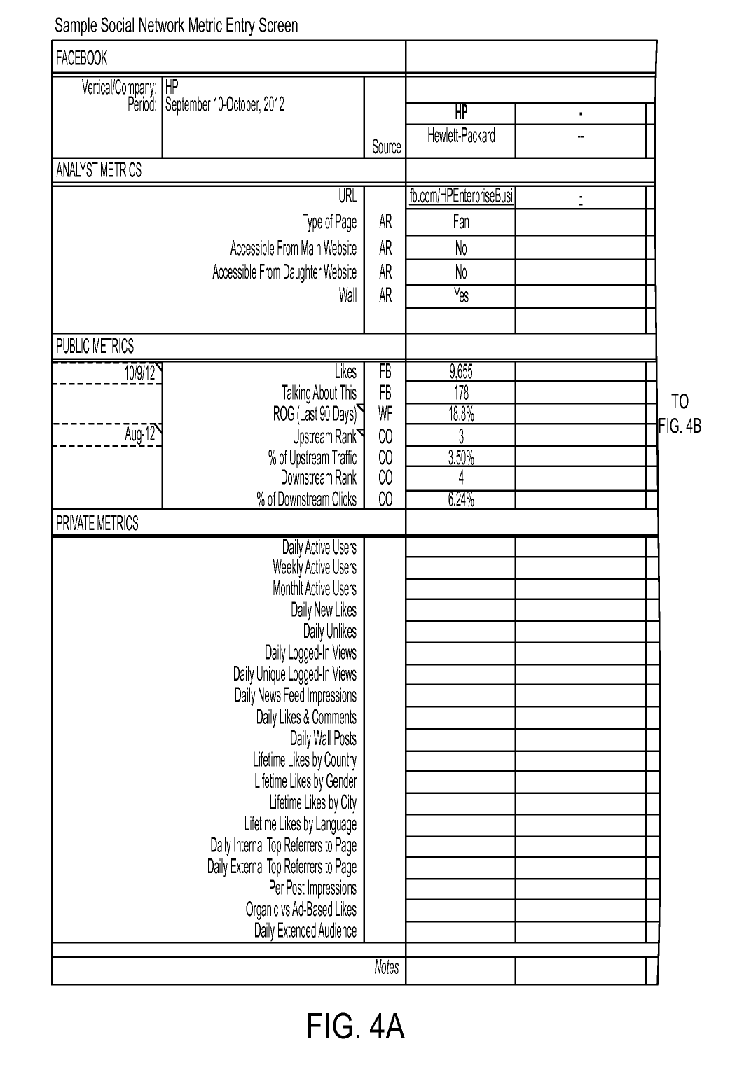

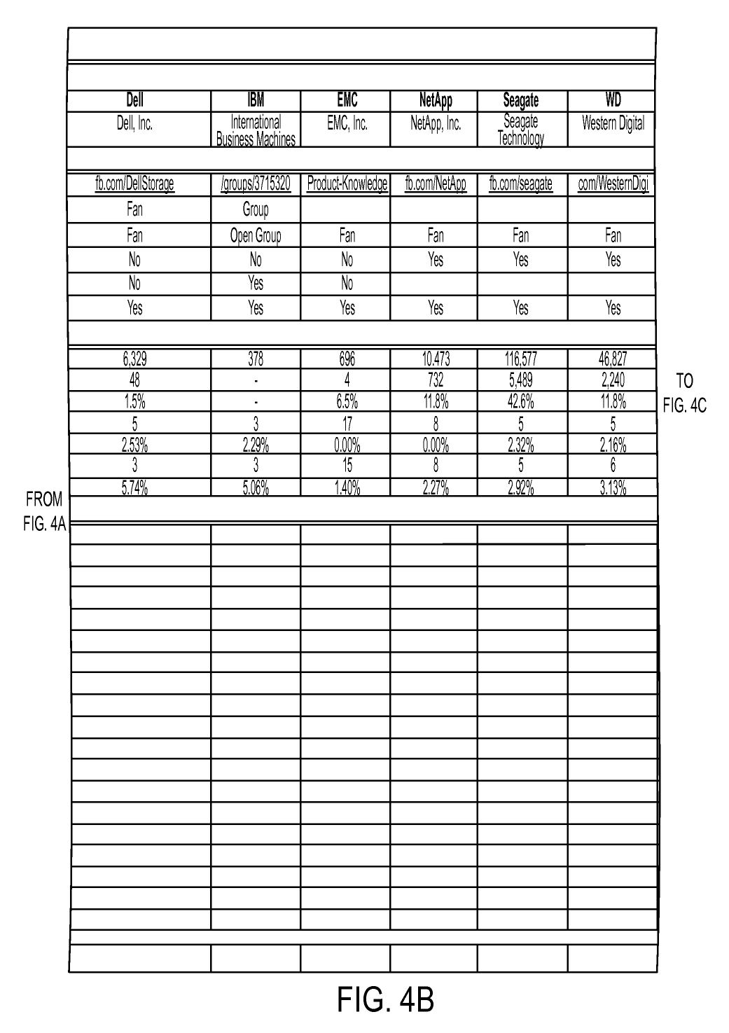

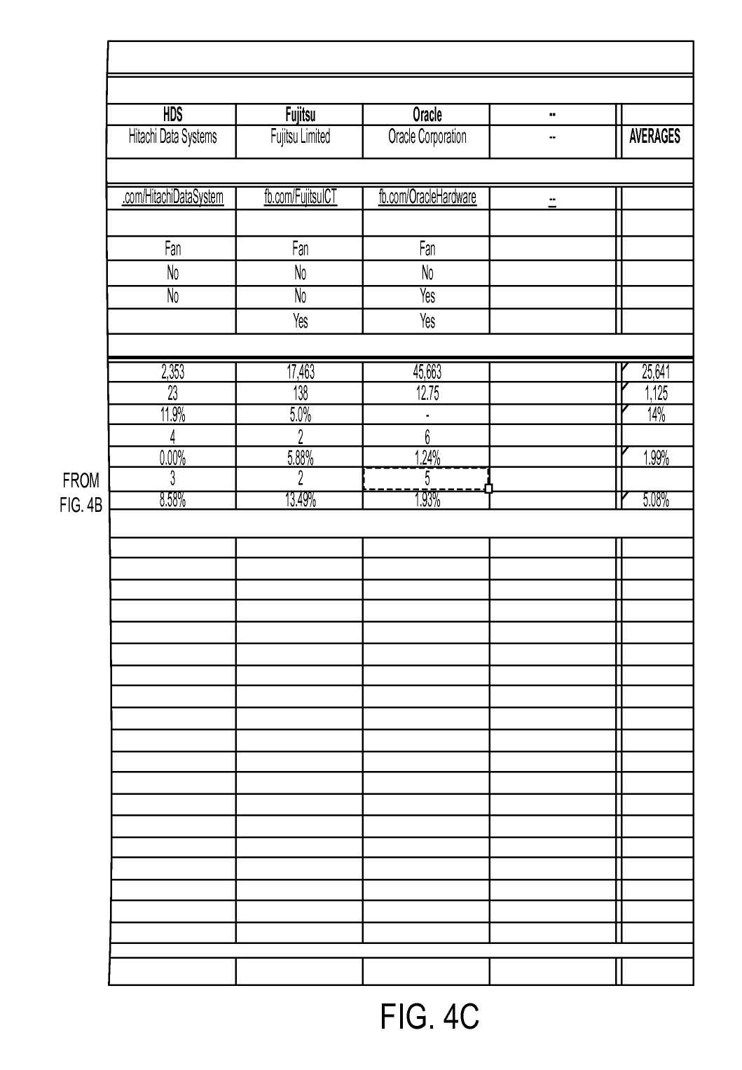

A plurality of marketing performance metrics are defined and stored in the non-volatile memory of the server 150. Examples of nine preferred marketing performance metrics are described below. The marketing performance metrics each utilize select social media metrics. Exemplary marketing performance metrics are shown in the screenshot of FIGS. 4A-4C. The screenshot of FIGS. 4A-4C is only for one social media source. Separate screenshots for each social media source can be provided.

Social media metrics are extracted from a plurality of social media sites using the brand keywords and industry keywords and stored in the non-volatile memory. The social media metrics are in typically in the form of raw numbers. The social media metrics can include a time constraint, such as the social media metric for any selected time period, for example a 1 month time period. The social media metrics from public social media, such as Facebook, Twitter and LinkedIn, are already named by the social media, as disclosed below, but can be renamed by the user as desired. Each of the social media can have multiple social media metrics. Social media metrics from marketing monitoring sources, such as Radian6, can be defined by desired search terms and named by the user or marketing expert to increase the accuracy of the metrics.

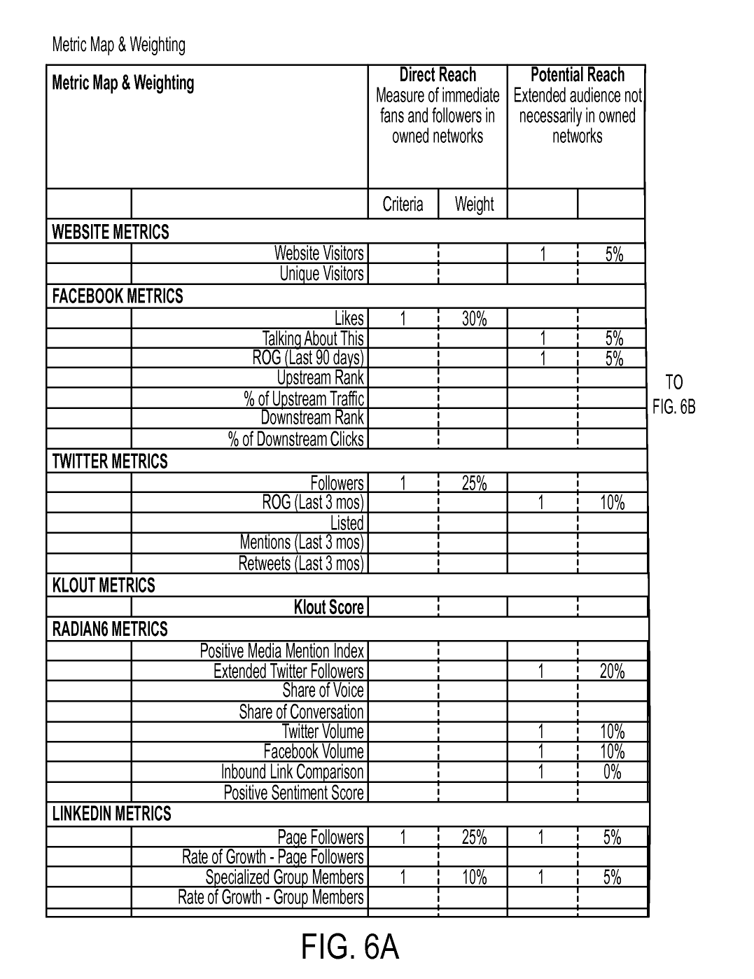

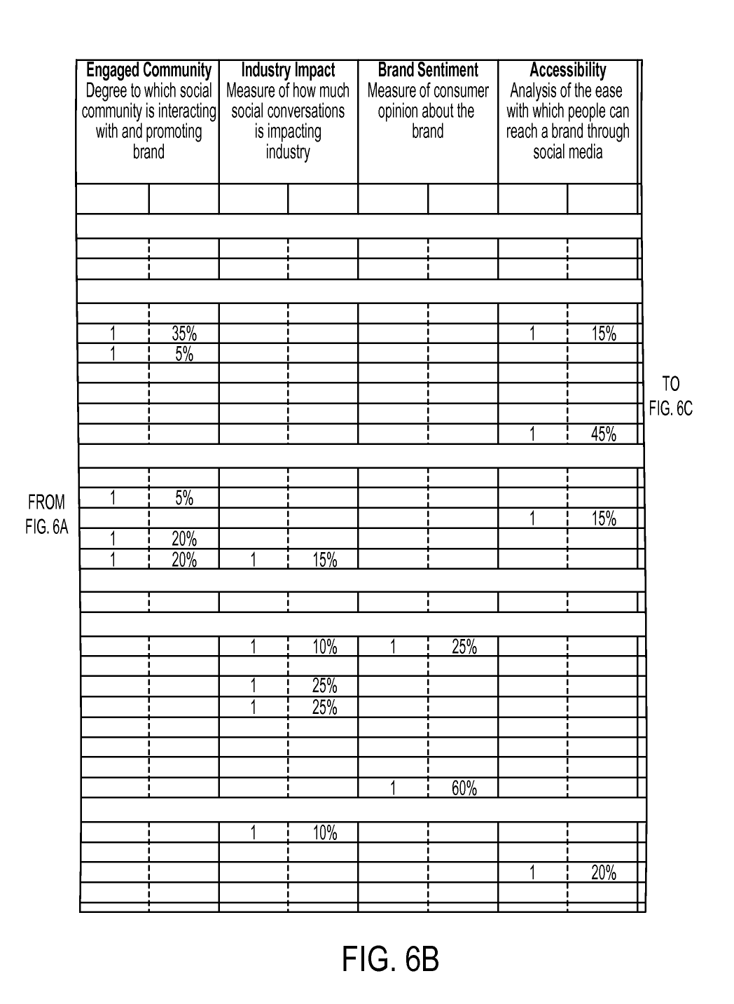

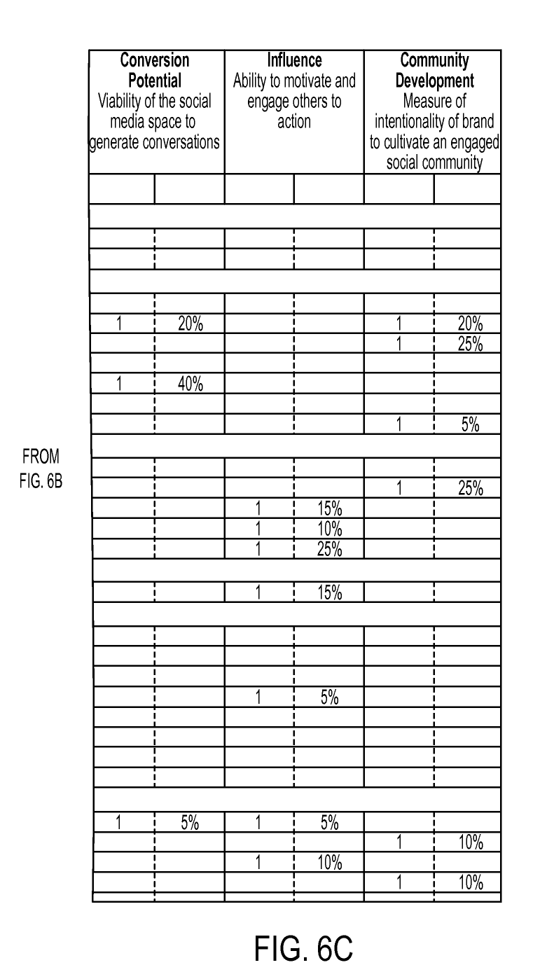

The social media metrics are preferably captured into the Excel spreadsheet or equivalent program and associated with the marketing performance metrics. Examples of the associations between the social media metrics and marketing performance metrics are shown below. See FIGS. 6A-6C for an example screenshot showing associations between the social media metrics and marketing performance metrics.

A portion of the novel methodology unique to the present invention is the way in which the metrics can be integrated and compiled to make up the scoring process for each of the nine marketing performance metrics. Each of the nine preferred marketing performance metrics utilizes a different number of social media metrics. Depending on the industry vertical being evaluated, for example whether it is a business to business or business to consumer focus, and any other variables the client chooses to highlight, the individual social media metrics can optionally be weighted to highlight social media effectiveness. The weighting of the social media metrics can also be based on marketing experience as desired. For example, if the client desires to focus on a specific social media, such as Twitter for a set time period, the weighting can be adjusted to highlight the Twitter analysis. Thus, the weighting can accommodate specific client goals. The weighting can also include marketing experience to further provide focused guidance to the client on how to achieve the desired goals. FIGS. 6A-6C illustrates and exemplary weighting of the social media metrics.

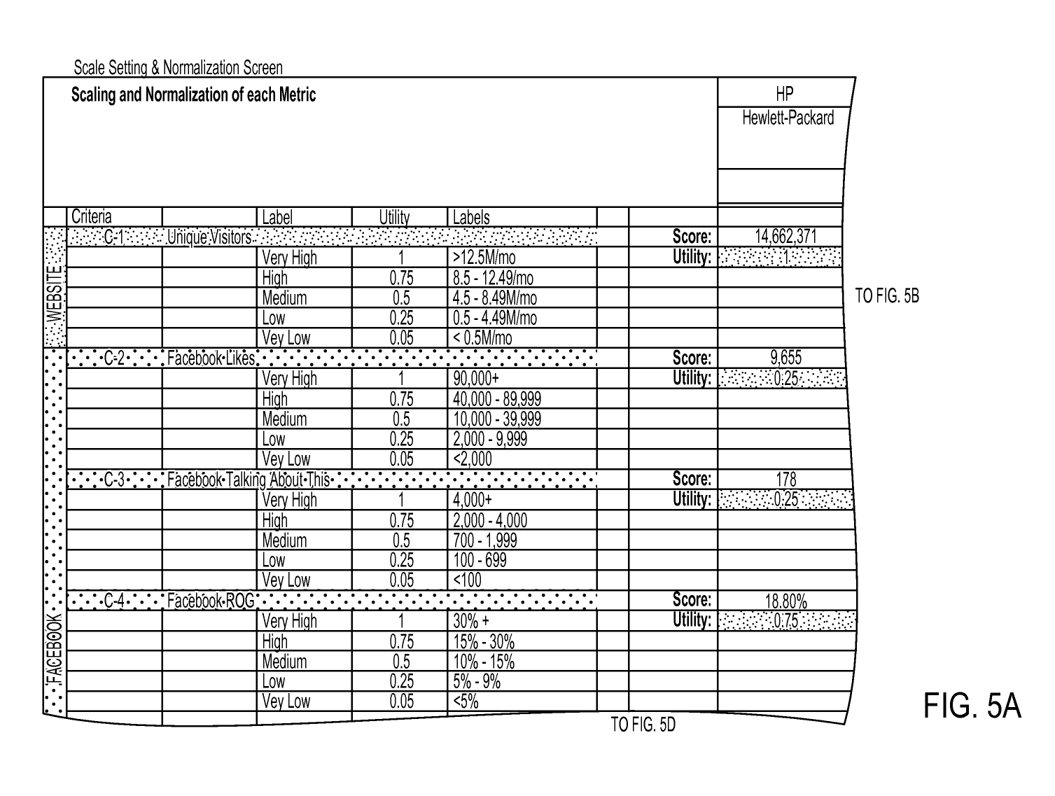

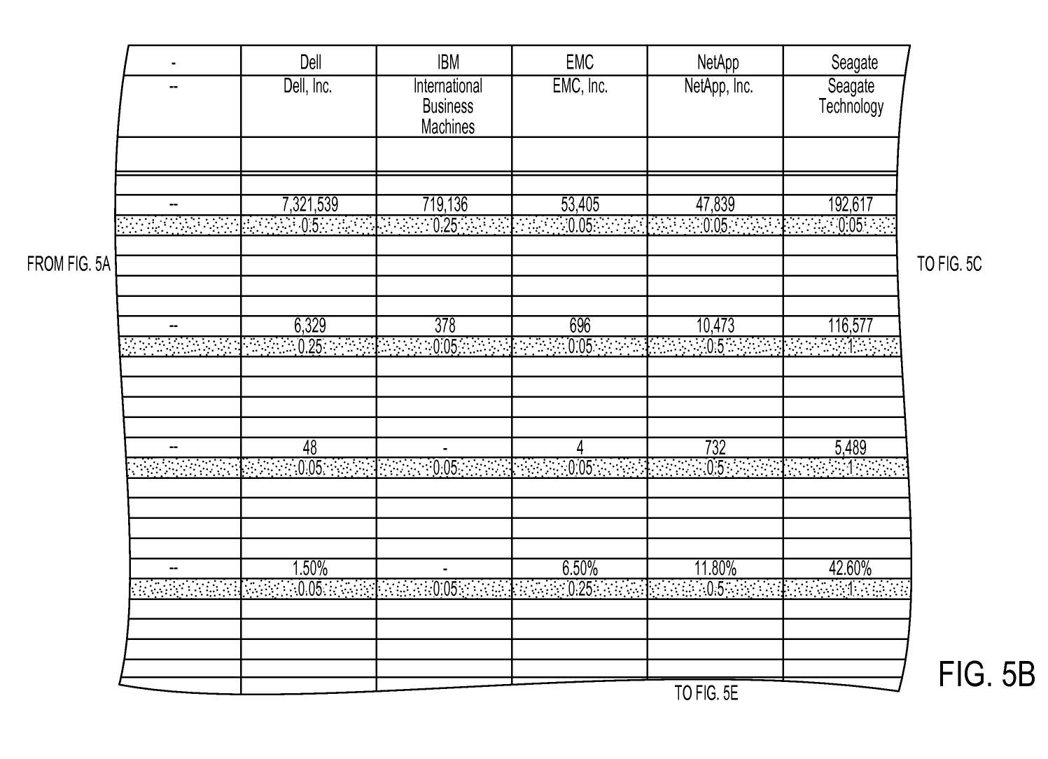

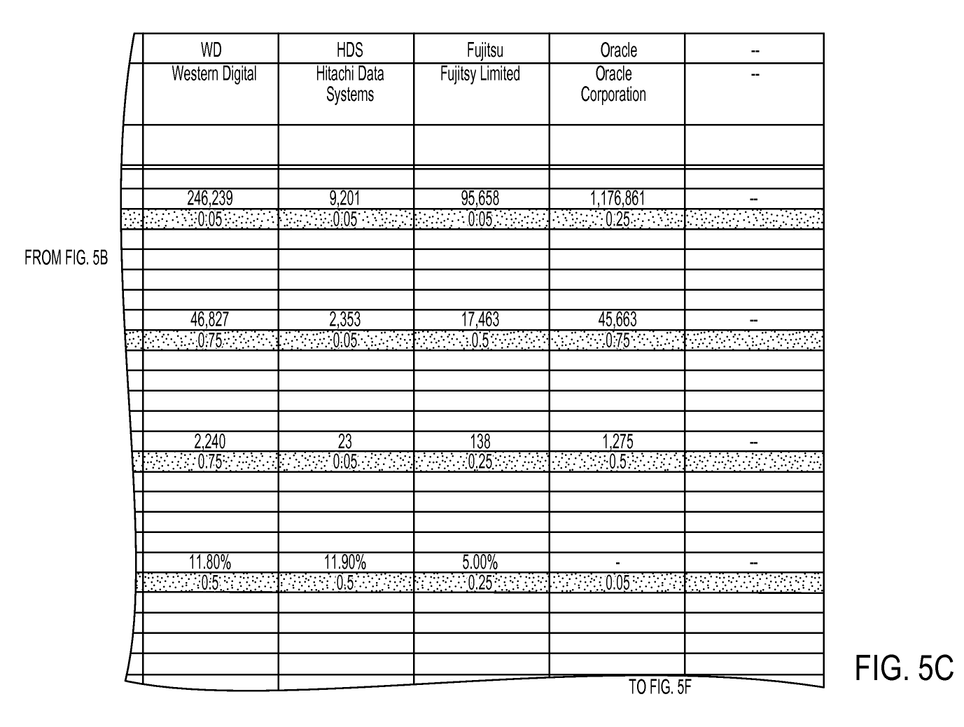

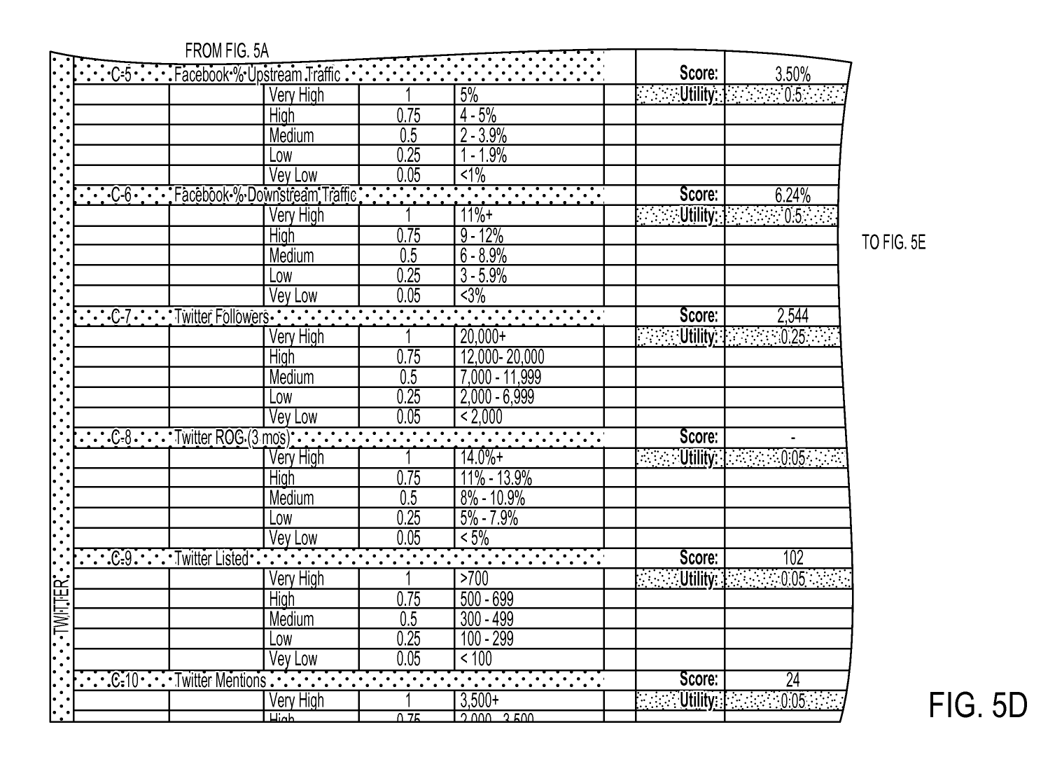

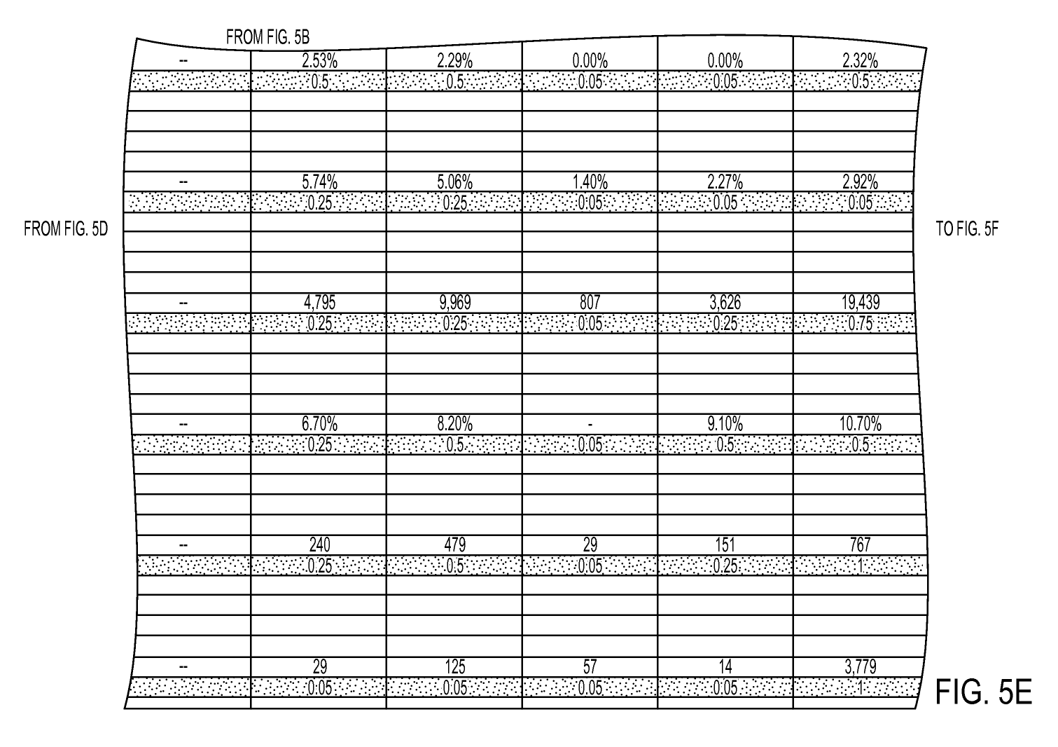

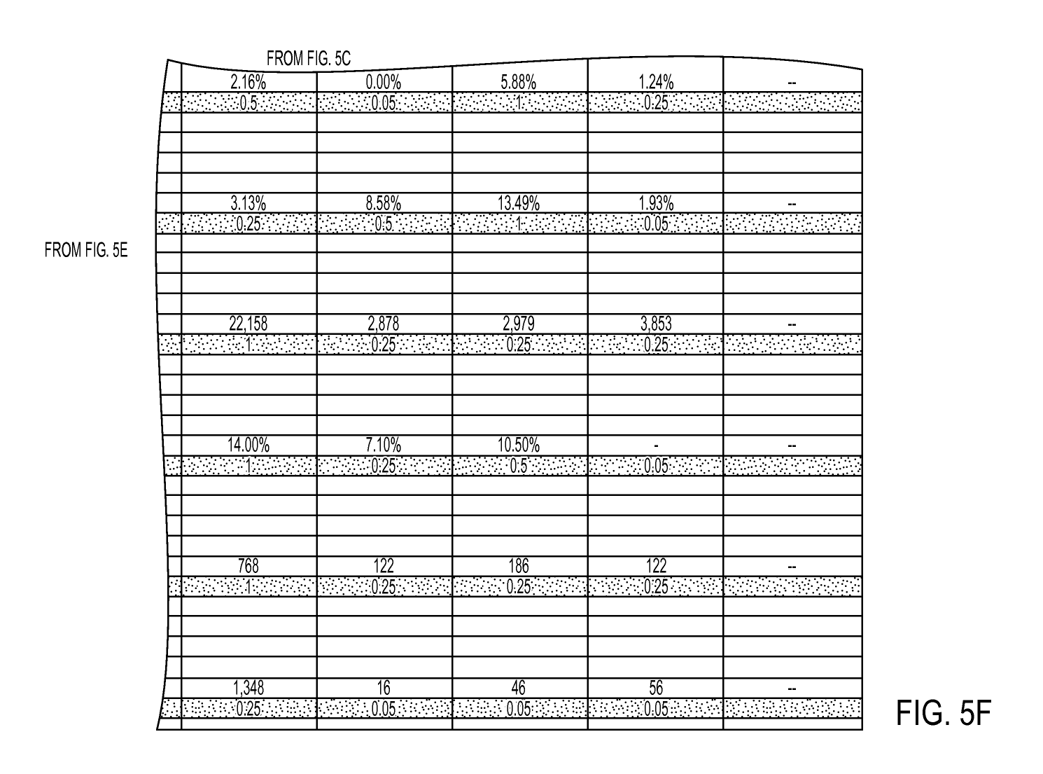

Each of the marketing performance metrics are calculated and then normalized so that the marketing performance metric scores can relate to one another. For example, once the data has been entered into an Excel file, each of the marketing performance metrics are put through a normalization process so that the benchmarks (scores) for each marketing performance metric relate to one another and can be easily compared by the client. See FIGS. 5A-5F for an exemplary screenshot of an exemplary normalization method.

An example of how the normalization can be performed is as follows. For each metric, the competitor brand set is analyzed to determine the highest benchmark for that specific metric. That benchmark is used to then set the normalization “high” and determine how the other levels of normalization can be set. For each metric, a brand will receive one of the following scores:
1.0—Perfect
0.75—High Performance
0.5—Moderate Performance
0.25—Low Performance
0.05—Poor or non-performance

As a further example, if the highest number of Facebook Likes (a social media metric) among the competitor brand set was 300,000, this would be the highest benchmark for that 30 day period and would set the bar for the “1.0” normalized score. A “0.75” score might then be given to any brands scoring between 200,000 and 300,000 and the same segmentation of the metric would follow down to the “0.05” normalization level.

Normalized benchmarks (scores) are produced for each of the marketing performance metrics. Since the benchmarks are normalized, the benchmarks for the client's brand can be directly compared to the benchmarks for the competitors' brands. Normalization can also be conducted so that the nine marketing performance metrics, when cumulatively summed together for each brand, equate to a 100% performance possibility.

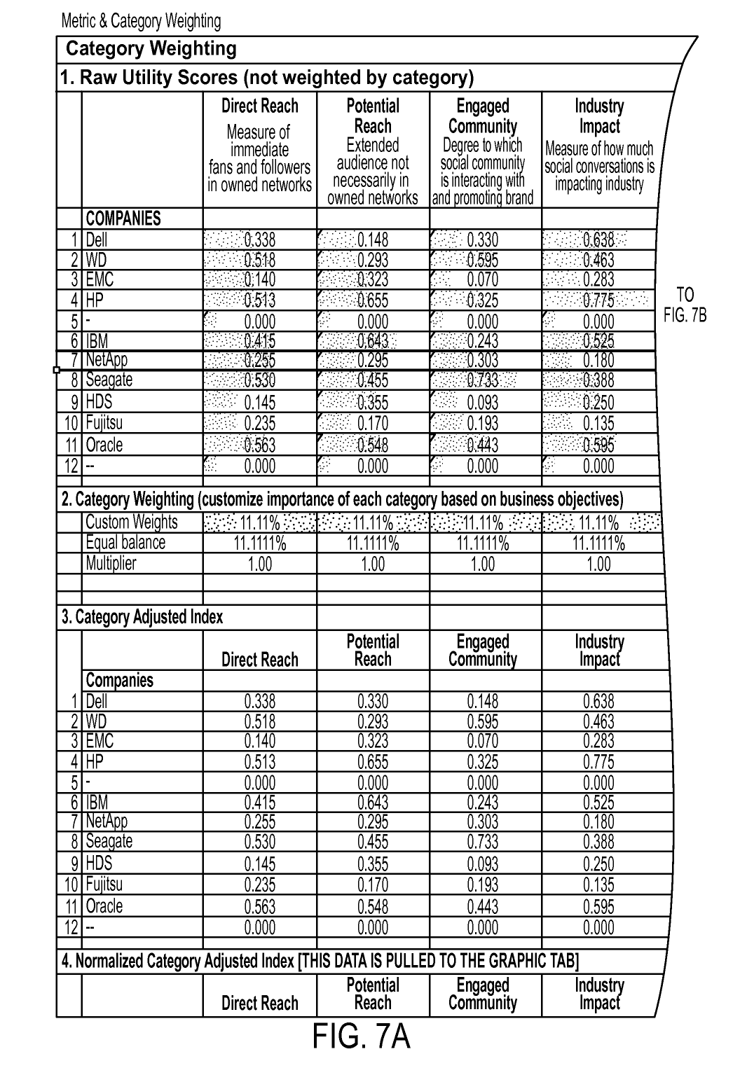

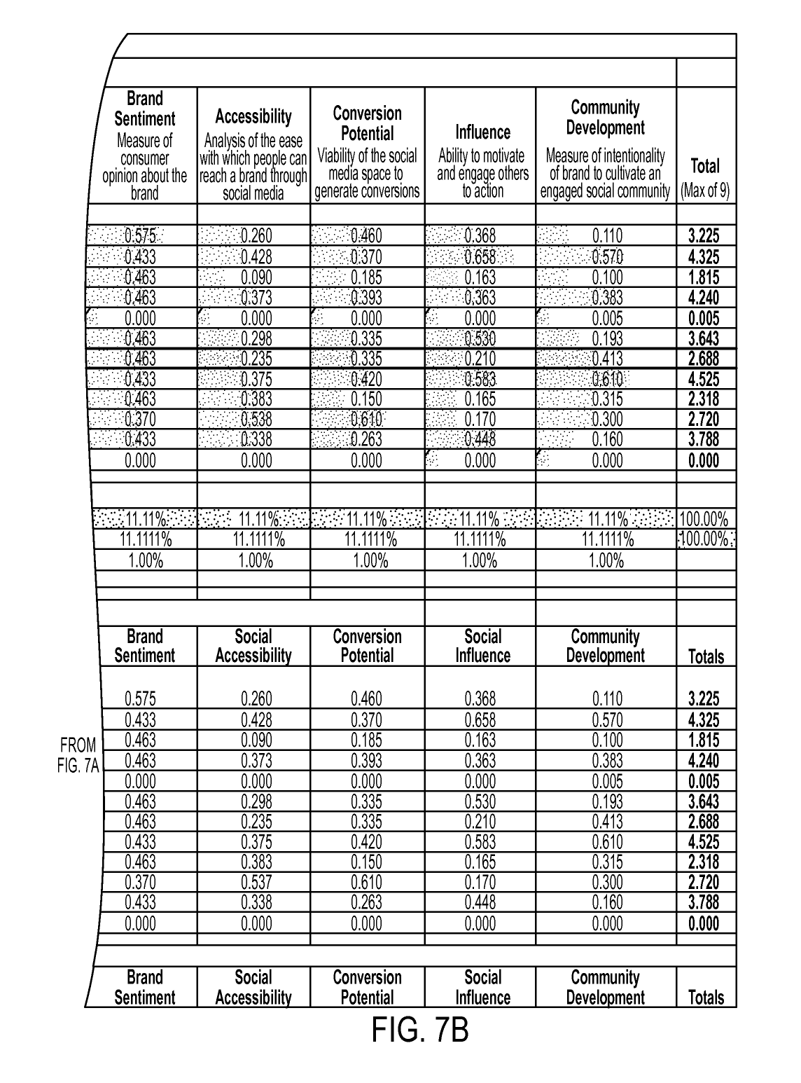

After the social media metrics are associated with the marketing performance metrics and entered, normalized and weighted, a raw benchmark for each of the nine marketing performance metrics is calculated. A second round of weighting can take place at this point if desired. An example of this second weighting is shown in the screenshot of FIGS. 7A-7B. Again, depending on the industry being considered, as well as the specific focus of the client, the individual nine marketing performance metrics can optionally be weighted differently as well to highlight aspects of the analysis most preferred to the client. For example, if the client desires to focus mainly on Direct Reach, the marketing performance metrics can be weighted to focus on Direct Reach compared to other marketing performance metrics for any desired time period. In this manner, the client's marketing can be adjusted using feedback from the method and system to enhance the desired Direct Reach benchmark of the client's brand compared to the competitors' brands.

The brands, after this final round of weighting, are now considered to have their normalized benchmarks for the nine marketing performance metrics as well as their overall, cumulative benchmark for the selected time period, such as a 30 day period. The cumulative benchmarks illustrate the client's brand competitive rankings (benchmark) against the defined competitors' brand set.

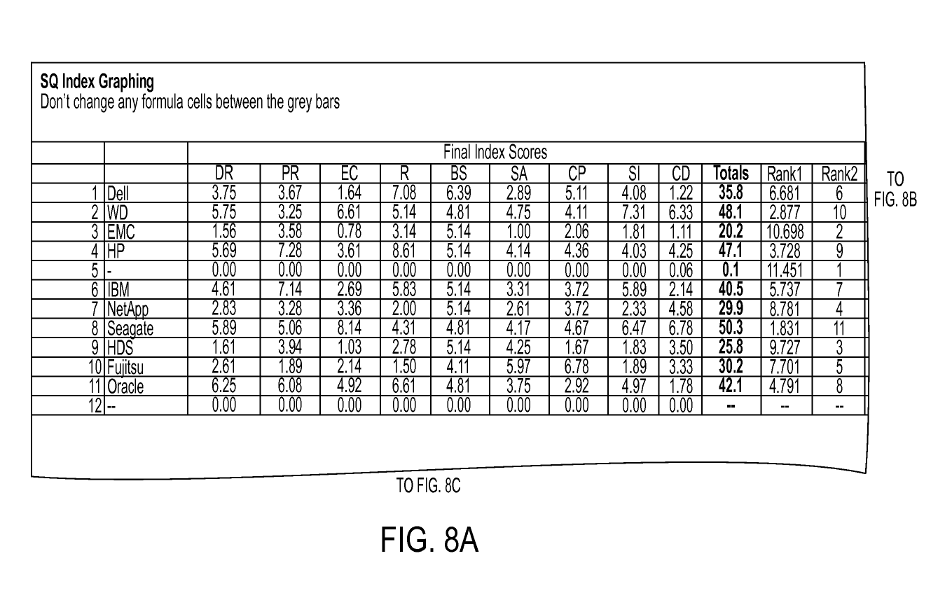

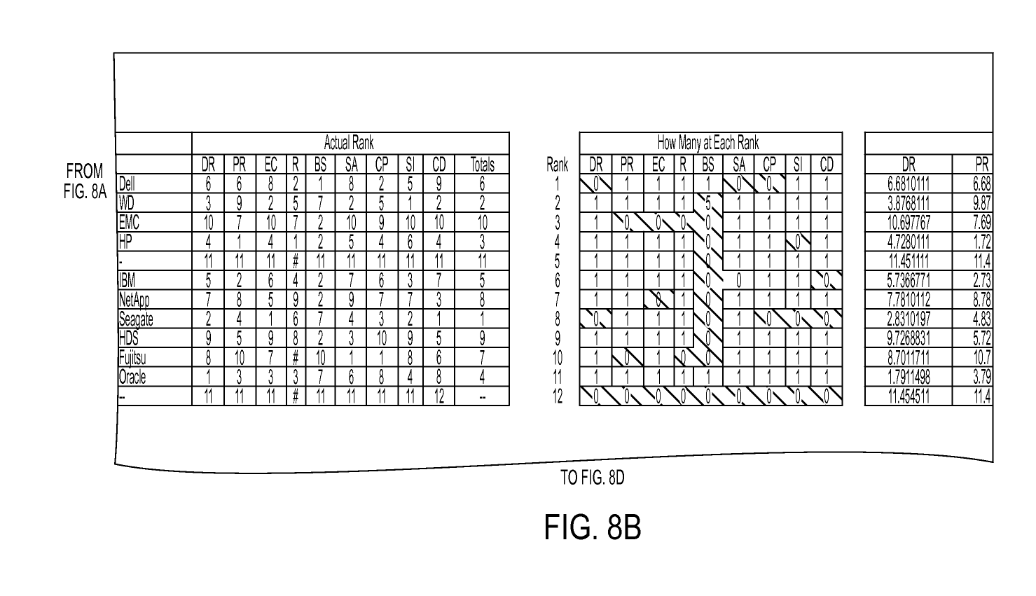

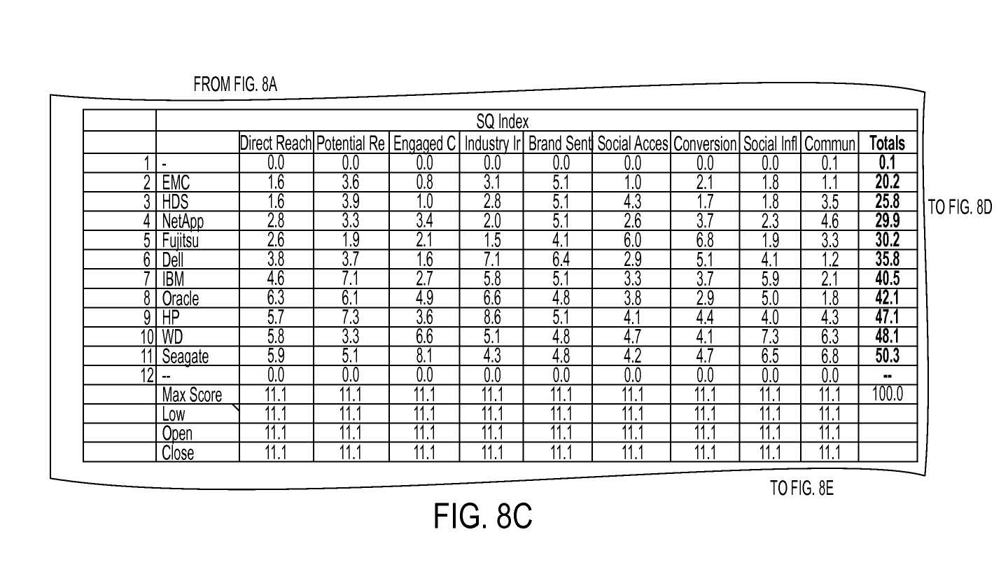

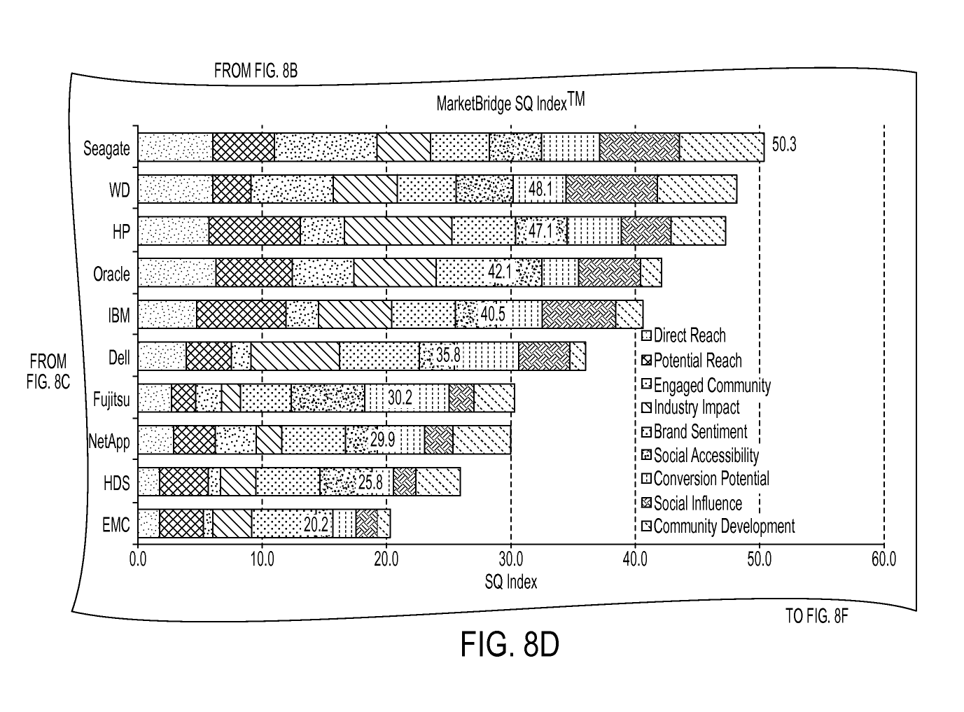

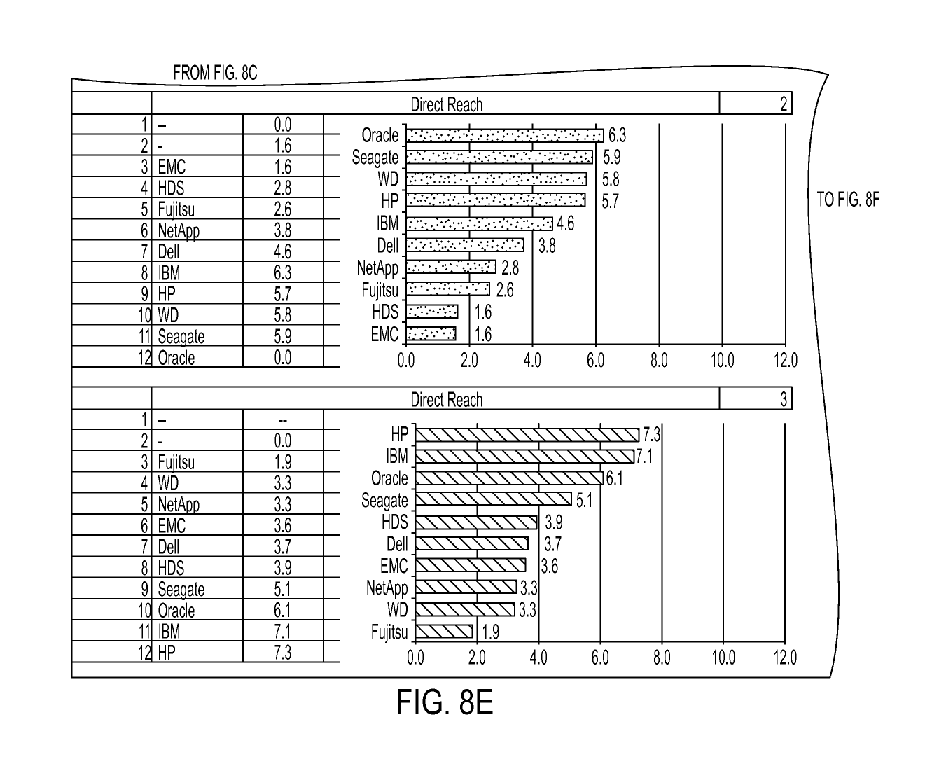

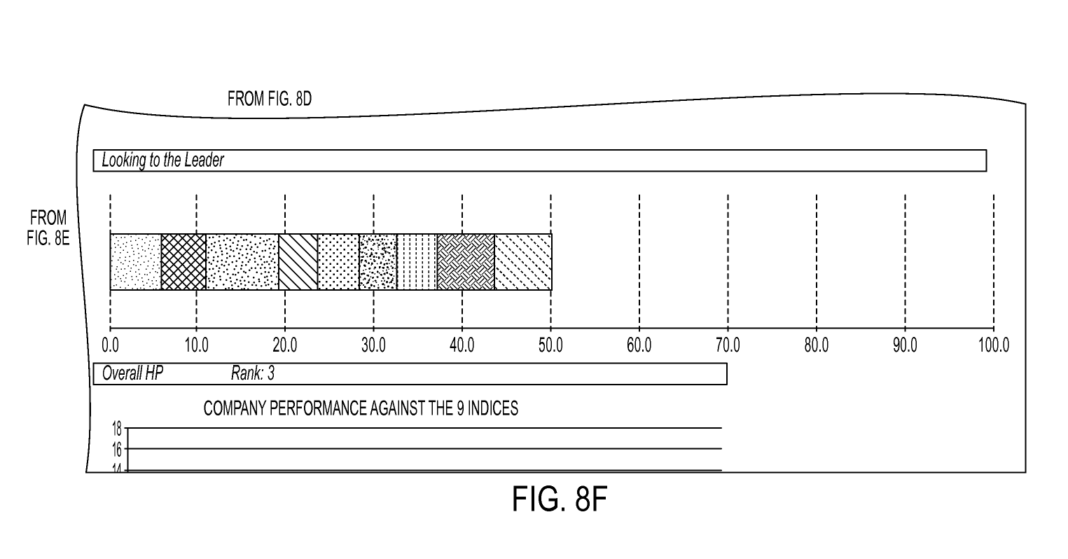

The benchmarks can be outputted in any manner desired, such as in graph form. Examples of preferred outputs are described as follows. FIGS. 8A-8F shows a screenshot of the entire final scoring of all social media utilized in the analysis.

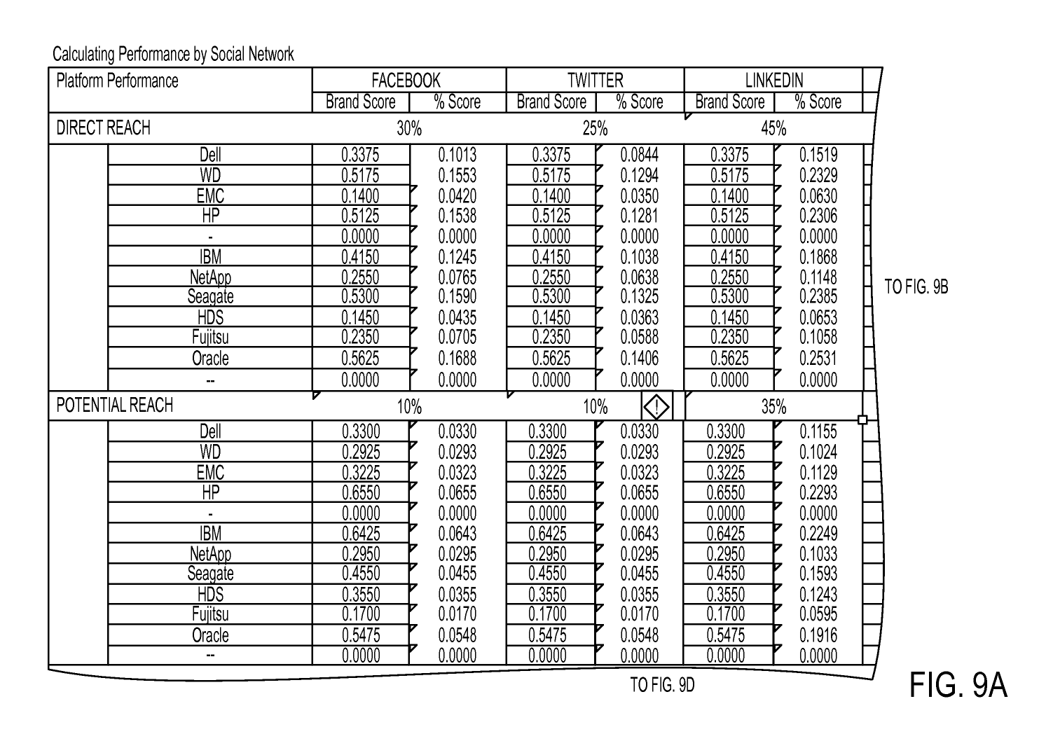

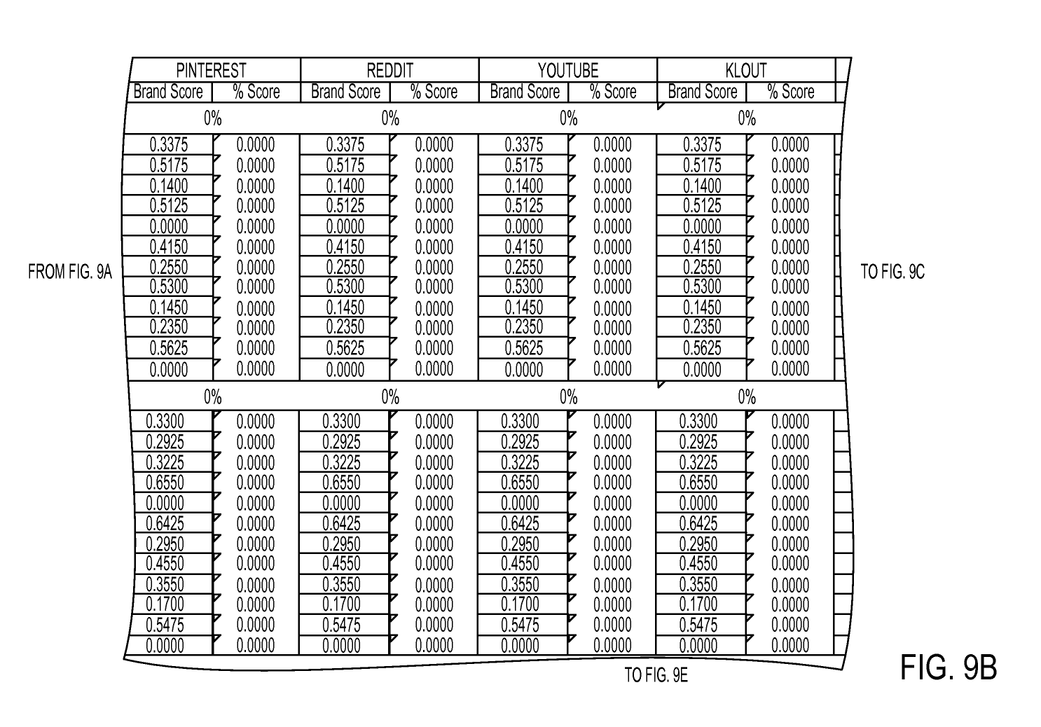

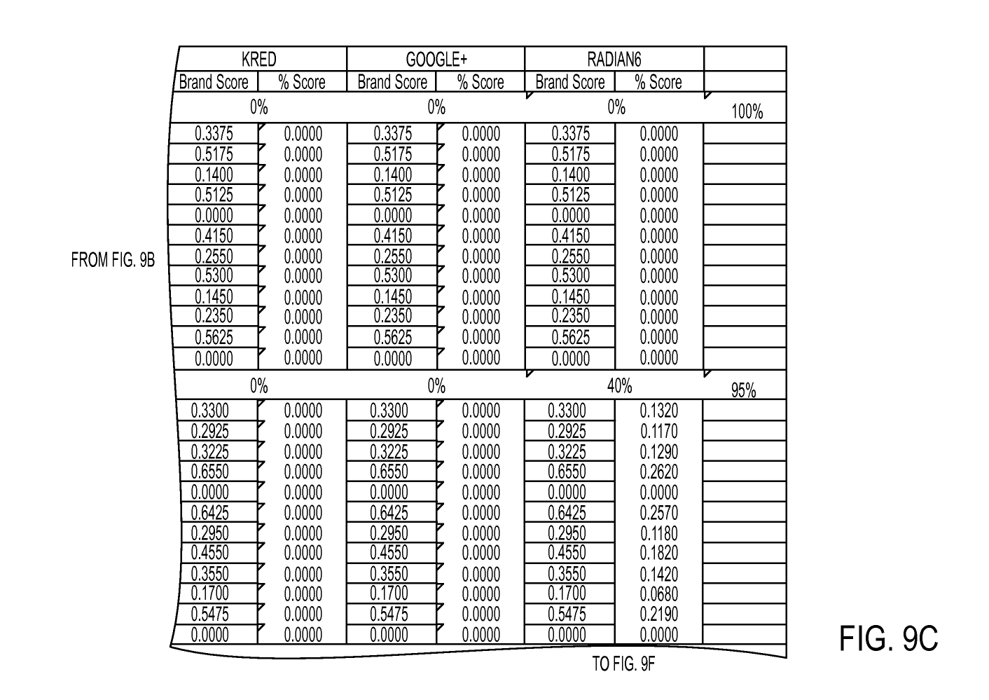

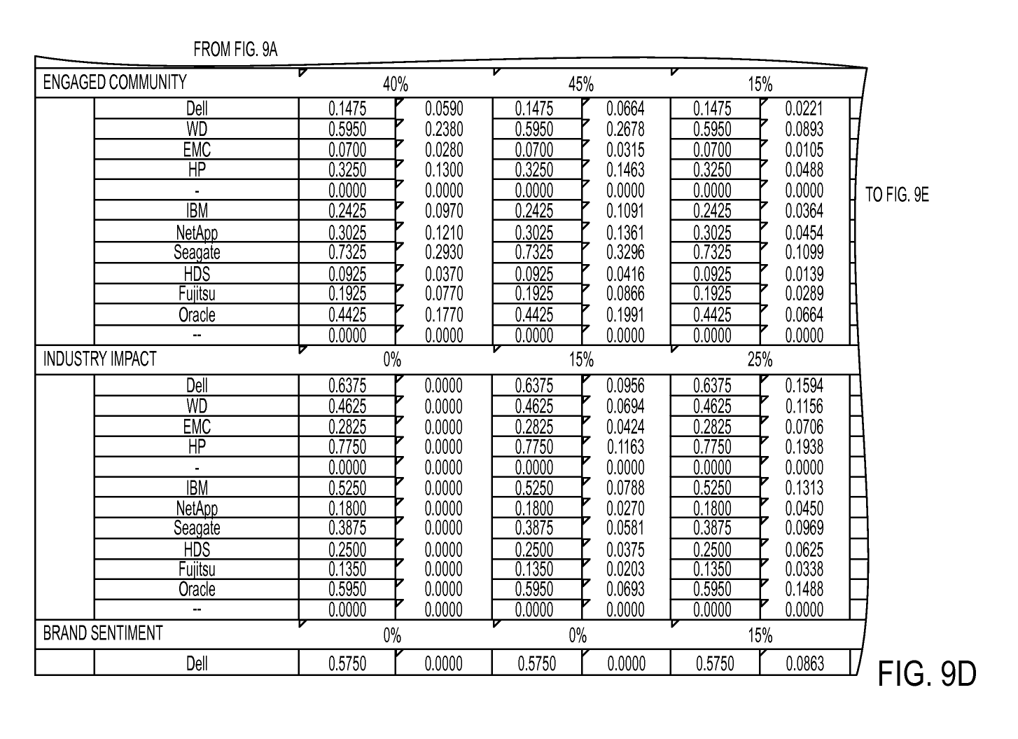

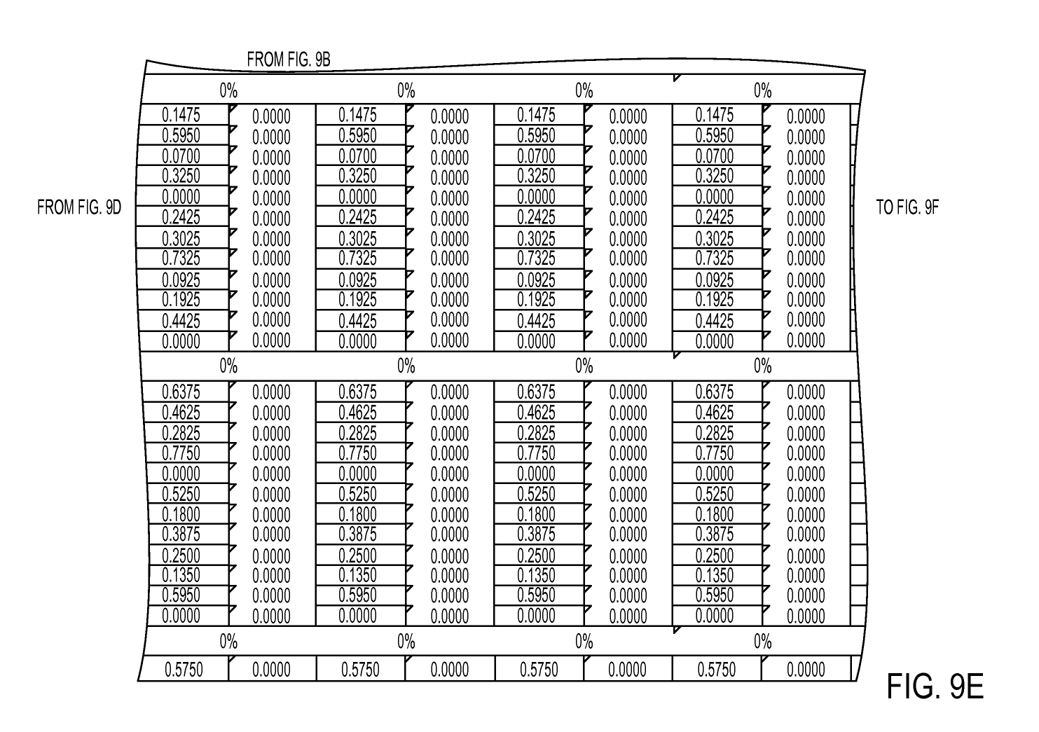

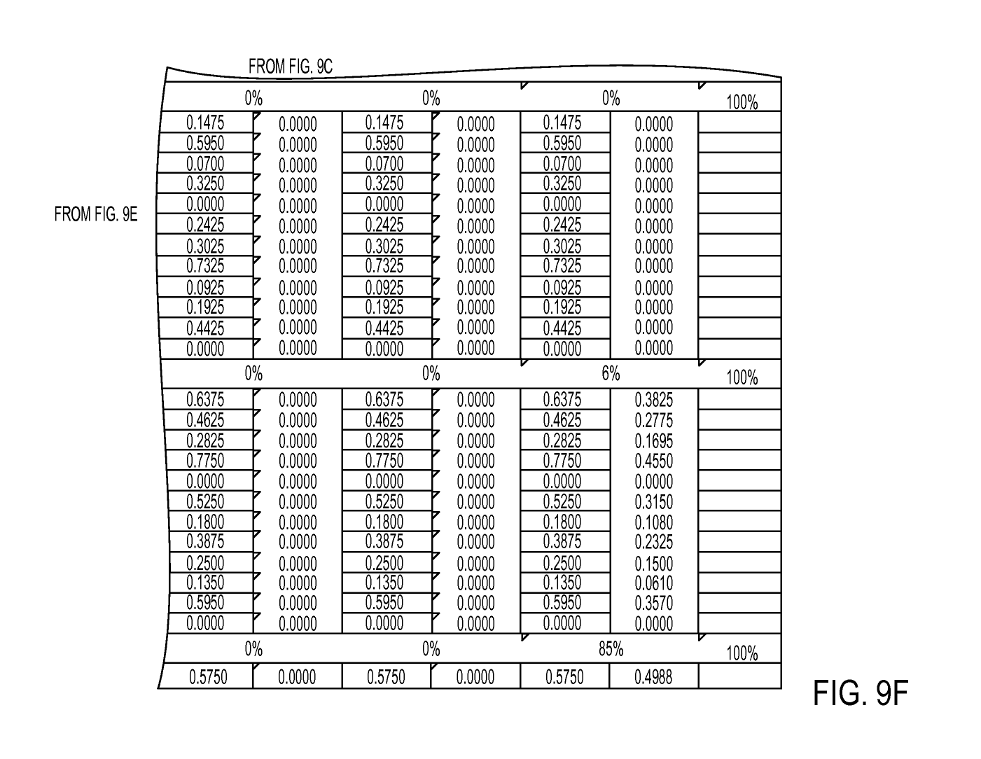

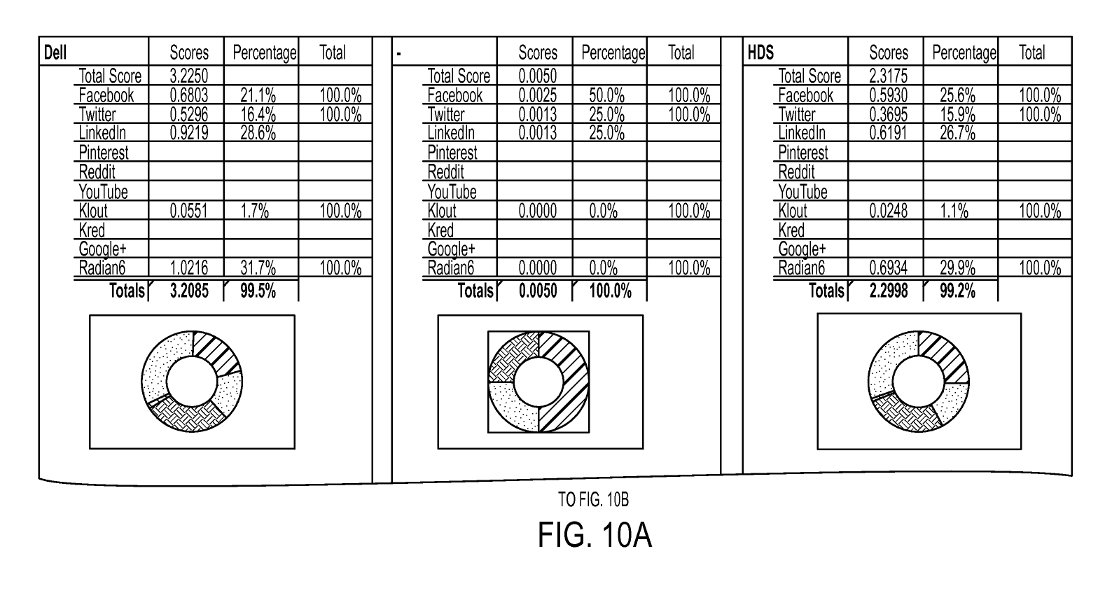

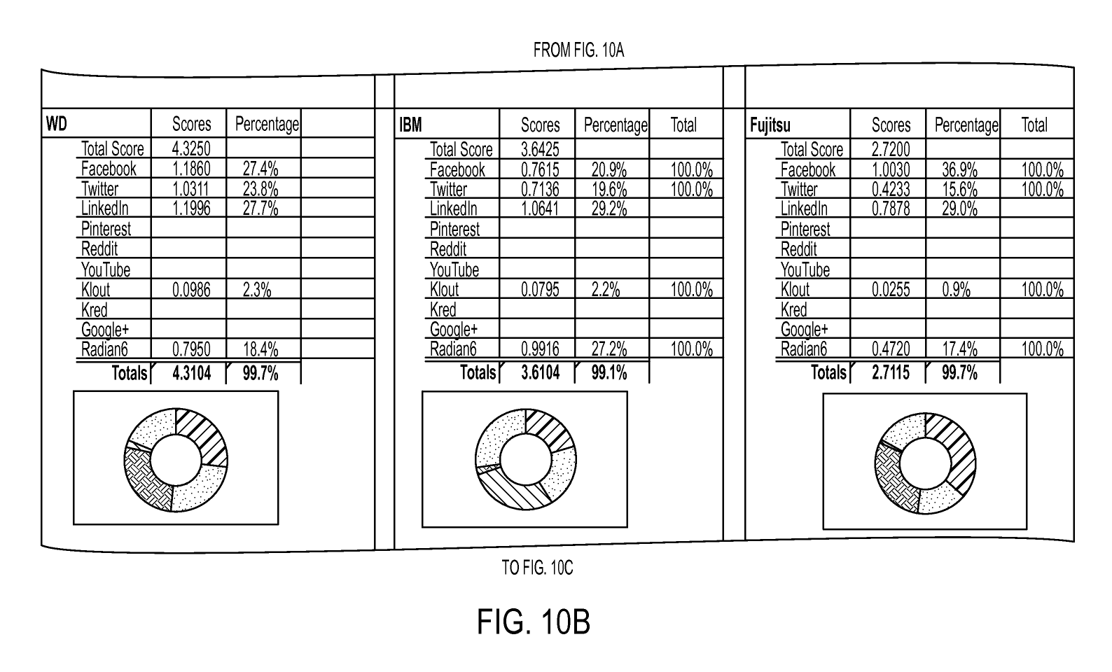

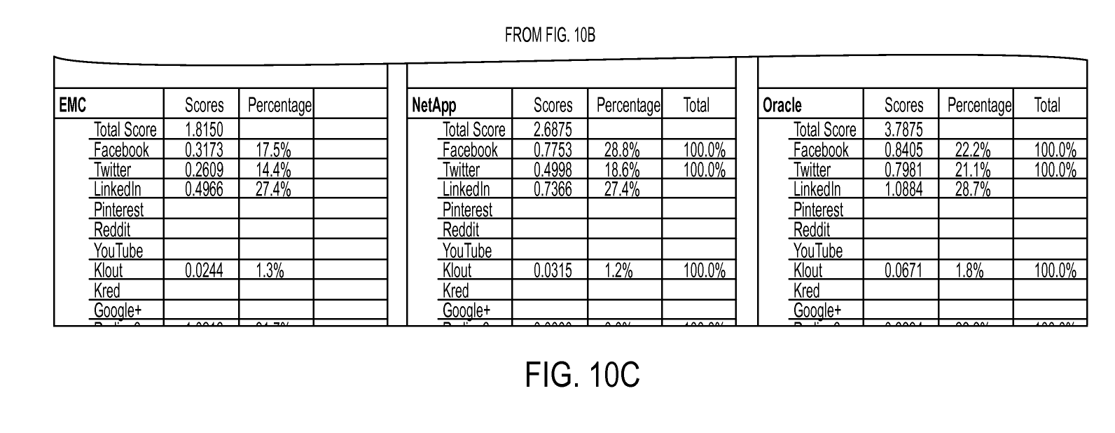

Summary Dashboard—The initial presentation of the client's overall marketing performance benchmark (SQI score) and rank. Additionally, the client's benchmarks for each marketing performance metric are presented as well as an analysis of the percentage that each social network contributed overall. Examples of the summary dashboard screenshots are shown in FIGS. 9A-9F and 10A-10C. FIGS. 9A-9F shows a screenshot of the performance for each separate social network utilized in the analysis. The screenshot of FIGS. 10A-10C shows the graphical output of FIGS. 9A-9F.

Competitive Benchmark Graphing—The entire competitor brands set is shown in a stacked bar comparison to show their overall score as well as how their benchmark scores fared.

Leading Brand Analysis—The brand that scored the highest overall for the desired time period has each of the nine marketing performance metrics analyzed to highlight the core metrics that led to their lead among all brands analyzed.

Client Brand Analysis—The brand being analyzed also has a categorical analysis conducted to compare their results in regards to the core metrics to how the brand leader performed.

Category Analysis—Each of the nine marketing performance metrics is presented individually in a simple bar chart for the competitor brand set. Further insights on how the brand leader performed versus the client brand are displayed.

Trends Analysis—A graph is presented to show how each brand has tracked over a desired time period. This is conducted to search for sustainable growth patterns.

Lessons From the Leaders—For each of the nine marketing performance metrics, the brand that led with the highest score is analyzed. The most significant factor or metric that played into the brand leader's score is defined, and the tactical process by which the score was achieved is described.

Pitfalls to Avoid—Similar to the above insights, but this section defines the brands that scored the lowest in each of the nine marketing performance metrics and where they most clearly missed opportunity.

Case Studies—For each report, anywhere from 1-3 case studies are presented. These case studies explicitly break down the most significant or outstanding trends for the time period being measured.

Competitive Attack Plan—Each brand inside the competitor brand set is analyzed for their most visible “weakness” or that marketing performance metric of the nine in which they performed the least favorably. Marketing strategies and solutions are identified for the client to put into place immediately to begin gaining traction against their competitors' brands.

Tactical Approach—Clear instructions are provided for how the client's brand can improve their performance in each of the nine marketing performance metrics.

Examples of suitable marketing performance metrics include, but are not limited to, the following nine categories:

Direct Reach—The degree to which the brand message can be broadcast to an immediately accessible social community.

Potential Reach—The potential amplification of the client's message to an extended audience based on the cumulative followings of those both inside and outside the client's direct social networks.

Engaged Community—A measure of how well the client's direct social community regular interacts with, shares and comments on the client's brand messages.

Industry Impact—The overall share of conversation the client's brand holds against industry-related discussions occurring in the social media space.

Brand Sentiment—The percentage of all discussions taking place related to the client's brand that carries a positive tone or sentiment.

Social Accessibility—An assessment of the ease with which the client's consumers can reach the client's brand for service-related inquiries through social channels.

Conversion Potential—A measure of the traffic that social media discussions are translating into traffic driving into the client's website.

Social Influence—How much your social community engages with and drives the client's followings to engage with or re-broadcast the client's brand message.

Community Development—The consistency and rate of growth of the client's combined social network followings.

Examples of social media metrics includes the following:

Website Unique Visitors

Source of Metric: Compete.com

Marketing Performance Metrics Integration: Potential Reach

Definition: Number of unique website visitors the core brand URL received over a 30 day period.

Facebook Likes

Source of Metric: Facebook

Marketing Performance Metrics Integration: Direct Reach

Definition: Cumulative number of people who have voluntarily associated or connected their profile with a brand's Facebook page by clicking the brand's Like button either on the page directly or a placed button by the brand.

Facebook People Talking About This

Source of Metric: Facebook

Marketing Performance Metrics Integration: Potential Reach; Engaged Community; Social Accessibility; Conversation Potential; Community Development

Definition: Number of unique users who have created a “story” about a page in a seven-day period. A “story” includes the number of likes, posts, shares, comments or check-ins.

Facebook Rate of Growth (ROG)

Source of Metric: Wildfire Monitor

Marketing Performance Metrics Integration: Potential Reach; Engaged Community; Community Development

Definition: Percent increase in the number of Likes for the brand page over a 90-day period.

Upstream %

Source of Metric: Experian Hitwise

Marketing Performance Metrics Integration: Conversion Potential

Definition: The percent of a brand's traffic entering their website that is coming from Facebook.

Downstream %

Source of Metric: Experian Hitwise

Marketing Performance Metrics Integration: Social Accessibility; Community Development

Definition: The percent of a brand's traffic leaving their website that is going to Facebook.

Twitter Followers

Source of Metric: Twitter

Marketing Performance Metrics Integration: Direct Reach

Definition: The total cumulative number of people who have followed your Twitter account and are receiving your tweets through Twitter.

Twitter Rate of Growth (ROG)

Source of Metric: Wildfire Interactive

Marketing Performance Metrics Integration: Potential Reach; Engaged Community; Community Development

Definition: Percent increase in the number of Followers for the official brand account over a 90-day period.

Twitter Listed

Source of Metric: TweetDeck

Marketing Performance Metrics Integration: Social Accessibility; Social Influence

Definition: The total number of “lists” that the brand's Twitter account has been added to by it's followers.

Twitter Mentions

Source of Metric: Radian6

Marketing Performance Metrics Integration: Engaged Community; Social Influence

Definition: The number of times a brand's Twitter username was included in a tweet by other Twitter users over a 30 day period.

Twitter ReTweets

Source of Metric: Radian6

Marketing Performance Metrics Integration: Engaged Community; Industry Impact; Social Influence

Definition: The number of tweets the brand had quoted or re-tweeted (as denoted by either the RT or VIA inclusion) over a 30 day period.

Klout Score

Source of Metric: Klout

Marketing Performance Metrics Integration: Social Influence

Definition: A single number between 0 and 100 that represents Klout's measure of “online influence” determined by an aggregation of multiple pieces of data about social media activity.

Positive Media Mention Index

Source of Metric: Radian6

Marketing Performance Metrics Integration: Industry Impact; Brand Sentiment

Definition: The percentage of posts and comments specifically across mainstream news outlets containing the mention of a brand name in a positive nature.

Extended Twitter Followers

Source of Metric: Radian6

Marketing Performance Metrics Integration: Potential Reach

Definition: The cumulative number of Twitter Followers from the Twitter accounts that have either mentioned a brand or Re-Tweeted a brand within a 30 day period.

Share of Voice

Source of Metric: Radian6

Marketing Performance Metrics Integration: Industry Impact

Definition: The percentage of total social discussions containing mentions of brands in a defined competitive that specifically name a brand.

Share of Conversation

Source of Metric: Radian6

Marketing Performance Metrics Integration: Industry Impact; Social Influence

Definition: The percentage of total social discussions around a specific industry that specifically mention the brand in conjunction with an industry keyword.

Twitter Volume

Source of Metric: Radian6

Marketing Performance Metrics Integration: Potential Reach

Definition: The total number of tweets mentioning a brand over a 30 day period.

Facebook Volume

Source of Metric: Radian6

Marketing Performance Metrics Integration: Potential Reach

Definition: The total number of Facebook posts mentioning a brand over a 30 day period.

Inbound Link Comparison

Source of Metric: Radian6

Marketing Performance Metrics Integration: Potential Reach, Industry Impact

Definition: The number of links to the brand website coming from outside the site.

Positive Sentiment Score

Source of Metric: Radian6

Marketing Performance Metrics Integration: Brand Sentiment

Definition: The percentage of posts and comments across all social media channels containing the mention of a brand name in a positive nature.

LinkedIn Page Followers

Source of Metric: LinkedIn

Marketing Performance Metrics Integration: Direct Reach; Potential Reach; Industry Impact; Conversion Potential; Social Influence

Definition: Cumulative number of people who have “followed” a brand's corporate LinkedIn page.

LinkedIn Page Rate of Growth (ROG)

Source of Metric: LinkedIn

Marketing Performance Metrics Integration: Community Development

Definition: Percent increase in the number of Followers for the official brand account over a 30-day period.

LinkedIn Group Members

Source of Metric: LinkedIn

Marketing Performance Metrics Integration: Brand Sentiment

Definition: Cumulative number of people who have joined the brand's specialized group which focuses on a specific sub-vertical or product.

LinkedIn Group Rate of Growth

Source of Metric: LinkedIn

Marketing Performance Metrics Integration: Community Development

Definition: Percent increase in the number of group members for the brand's specialized group over a 30-day period.

Employees on LinkedIn

Source of Metric: LinkedIn

Marketing Performance Metrics Integration: Direct Reach; Potential Reach; Engaged Community

Definition: The total number of current employees for the company who have active LinkedIn profiles and have listed the brand as their current employer.

LinkedIn Product Recommendations

Source of Metric: LinkedIn

Marketing Performance Metrics Integration: Engaged Community; Industry Impact; Brand Sentiment; Conversion Potential; Social Influence

Definition: The number of “recommendations” a sub-vertical or product has received over a 30-day period from the group's page.

LinkedIn Group Discussions

Source of Metric: LinkedIn

Marketing Performance Metrics Integration: Social Influence

Definition: User discussions, user-submitted articles, and RSS items promoted by the group manager.

LinkedIn Group Comments

Source of Metric: LinkedIn

Marketing Performance Metrics Integration: Engaged Community

Definition: The number of comments over a 30 day period registered on a group discussion.

LinkedIn Upstream %

Source of Metric: LinkedIn

Marketing Performance Metrics Integration: Conversion Potential

Definition: The percent of a brand's traffic entering their website that is coming from LinkedIn.

LinkedIn Downstream %

Source of Metric: Radian6

Marketing Performance Metrics Integration: Social Accessibility

Definition: The percent of a brand's traffic leaving their website that is going to LinkedIn.

LinkedIn Specialized Group % Senior

Source of Metric: Radian6

Marketing Performance Metrics Integration: Potential Reach; Industry Impact; Conversion Potential

Definition: The percent of a group's membership that is holding a senior level position.

Another embodiment of the invention relates to a computer program code (software). The computer program product comprises a computer usable medium having a computer readable program code embodied therein, wherein the computer readable program code being constructed to be executed to implement the method of providing a brand benchmark of marketing performance for a client brand as described herein. Computer usable medium are well known, and any medium capable of storing the computer program code can be used. Non-limiting examples of the computer usable medium include semiconductor, magnetic disk, optical disk (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

We claim:

1. A method of providing a brand benchmark of marketing performance for a client brand comprising:
defining an industry arena or vertical;
providing a client brand within the defined industry arena or vertical;
providing a group of competing brands within the defined industry arena or vertical;
providing brand keyword groups for the client brand and each competing brand to capture variations of the client brand name and variations of the competing brand names;
providing industry keyword groups to provide a sampling of discussions relating to the client brand and competing brands;
defining a plurality of marketing performance metrics;
extracting social media metrics from a plurality of social media sites using the brand keywords and industry keywords;
associating the social media metrics with the marketing performance metrics;
calculating benchmarks for each marketing performance metric for each brand, wherein a first marketing performance metric utilizing a first social media metric and a second marketing performance metric utilizing a second social media metric;
normalizing the marketing performance metrics so that the marketing performance metric benchmarks can relate to one another;
calculating an overall benchmark for each brand based on the marketing performance metric benchmarks; and
outputting at least one of the benchmarks.

2. The method according to claim 1, further comprising weighing the social media metrics.

3. The method according to claim 1, further comprising weighing the marketing performance metrics.

4. The method according to claim 1, further comprising providing at least five competing bands.

5. The method according to claim 1, further comprising defining keyword groups to capture daughter brands.

6. The method according to claim 1, wherein the marketing performance metrics comprise
direct research defined as a degree to which a brand message can be broadcast to an immediately accessible social community;
potential reach, defined as the potential amplification of a message to an extended audience based on the cumulative followings of those both inside and outside the direct social networks;
engaged community, defined as a measure of how well the direct social community regular interacts with, shares and comments on your brand messages;
industry impact, defined as the overall share of conversation your brand holds against industry-related discussions occurring in the social media space;
brand sentiment, defined as the percentage of all discussions taking place related to your brand that carries a positive tone or sentiment;
social accessibility, defined as an assessment of the ease with which your consumers can reach your brand for service-related inquiries through social channels;
conversion potential, defined as a measure of the traffic that social media discussions are translating into traffic driving into your website;
social influence, defined as how much your social community engages with and drives their followings to engage with or re-broadcast your brand message; and
community development, defined as the consistency and rate of growth of your combined social network followings.

7. The method according to claim 1, further comprising identifying how the specific brand can increase performance in a marketing performance metric.

8. The method according to claim 1, wherein the benchmarks are outputted graphically.

9. The method according to claim 1, further comprising outputting at least one benchmark so that the entire competitor brands set is shown in a stacked bar comparison to show their overall score as well as how their benchmark scores fared.

10. The method according to claim 1, further comprising outputting at least one benchmark so that the brand that scored the highest overall for the desired time period has each of the nine marketing performance metrics analyzed to highlight the core metrics that led to their lead among all brands analyzed.

11. The method according to claim 1, further comprising outputting at least one benchmark so that the brand that the brand being analyzed also has a categorical analysis conducted to compare their results in regards to the core metrics to how the brand leader performed.

12. The method according to claim 1, further comprising outputting at least one benchmark so that each of the nine marketing performance metrics is presented individually in a simple bar chart for the competitor brand set and further insights on how the brand leader performed versus the client brand are displayed.

13. The method according to claim 1, further comprising outputting at least one benchmark so that a graph is presented to show how each brand has tracked over a desired time period and so that sustainable growth patterns can be disclosed.

14. The method according to claim 1, further comprising outputting at least one benchmark so that for each of the nine marketing performance metrics, the brand that led with the highest score is analyzed, the most significant factor or metric that played into the brand leader's score is defined, and the tactical process by which the score was achieved is described.

15. The method according to claim 1, further comprising outputting at least one benchmark so that the brands that scored the lowest in each of the nine marketing performance metrics are displayed and where the lowest brands missed opportunity.

16. The method according to claim 1, further comprising outputting at least one benchmark so that for each report from 1-3 case studies are presented that break down the most significant or outstanding trends for the time period being measured.

17. The method according to claim 1, further comprising outputting at least one benchmark so that each brand inside the competitor brand set is analyzed for their e weakness or the marketing performance metric in which they performed the least favorably, and marketing strategies and solutions are identified for the client to put into place to begin gaining traction against the competitors' brands.

18. The method according to claim 1, further comprising outputting at least one benchmark so that instructions are provided for how the client's brand can improve their performance in each of the nine marketing performance metrics.

19. A system for providing a brand benchmark of marketing performance for a client brand comprising:
a server being in communication with or comprising at least one non-volatile memory;
a user interface device in communication with the server; and
computer program code configured to store in the non-volatile memory a defined industry arena or vertical, a client brand within the defined industry arena or vertical, a group of competing brands within the defined industry arena or vertical, brand keyword groups for the client brand and each competing brand to capture variations of the client brand name and variations of the competing brand names, industry keyword groups to provide a sampling of discussions relating to the client brand and competing brands, and a plurality of marketing performance metrics, wherein the code being configured to extract social media metrics from a plurality of social media sites using the brand keywords and industry keywords, associate the social media metrics with the marketing performance metrics, calculate benchmarks for each marketing performance metric for each brand, wherein a first marketing performance metric utilizing a first social media metric and a second marketing performance metric utilizing a second social media metric, normalize the marketing performance metrics so that the marketing performance metric benchmarks can relate to one another, calculate an overall benchmark for each brand based on the marketing performance metric benchmarks, and output at least one of the benchmarks.

20. The system according to claim 19, wherein the software is further configured to store and utilize weighing of the social media metrics.

21. The system according to claim 19, wherein the software is further configured to store and utilize weighing the marketing performance metrics.

22. The system according to claim 19, wherein the software is further configured to store at least five competing bands.

23. The system according to claim 19, wherein the software is further configured to store and utilize keyword groups to capture daughter brands.

24. The system according to claim 19, wherein the marketing performance metrics comprise
direct research defined as a degree to which a brand message can be broadcast to an immediately accessible social community;
potential reach, defined as the potential amplification of a message to an extended audience based on the cumulative followings of those both inside and outside the direct social networks;
engaged community, defined as a measure of how well the direct social community regular interacts with, shares and comments on your brand messages;
industry impact, defined as the overall share of conversation your brand holds against industry-related discussions occurring in the social media space;
brand sentiment, defined as the percentage of all discussions taking place related to your brand that carries a positive tone or sentiment;
social accessibility, defined as an assessment of the ease with which your consumers can reach your brand for service-related inquiries through social channels;
conversion potential, defined as a measure of the traffic that social media discussions are translating into traffic driving into your website;
social influence, defined as how much your social community engages with and drives their followings to engage with or re-broadcast your brand message; and
community development, defined as the consistency and rate of growth of your combined social network followings.

25. The system according to claim 19, wherein the code is further configured to identify how the specific brand can increase performance in a marketing performance metric.

26. The system according to claim 19, wherein the code is further configured to, output the benchmarks graphically.

27. The system according to claim 19, wherein the code is further configured to output at least one benchmark so that the entire competitor brands set is shown in a stacked bar comparison to show their overall score as well as how their benchmark scores fared.

28. The system according to claim 19, wherein the code is further configured to output least one benchmark so that the brand that scored the highest overall for the desired time period has each of the nine marketing performance metrics analyzed to highlight the core metrics that led to their lead among all brands analyzed.

29. The system according to claim 19, wherein the code is further configured to output at least one benchmark so that the brand that the brand being analyzed also has a categorical analysis conducted to compare their results in regards to the core metrics to how the brand leader performed.

30. The system according to claim 19, wherein the code is further configured to output at least one benchmark so that each of the nine marketing performance metrics is presented individually in a simple bar chart for the competitor brand set and further insights on how the brand leader performed versus the client brand are displayed.

31. The system according to claim 19, wherein the code is further configured to output at least one benchmark so that a graph is presented to show how each brand has tracked over a desired time period and so that sustainable growth patterns can be disclosed.

32. The system according to claim 19, wherein the code is further configured to output at least one benchmark so that for each of the nine marketing performance metrics, the brand that led with the highest score is analyzed, the most significant factor or metric that played into the brand leader's score is defined, and the tactical process by which the score was achieved is described.

33. The system according to claim 19, wherein the code is further configured to output at least one benchmark so that the brands that scored the lowest in each of the nine marketing performance metrics are displayed and where the lowest brands missed opportunity.

34. The system according to claim 19, wherein the code is further configured to output at least one benchmark so that for each report from 1-3 case studies are presented that break down the most significant or outstanding trends for the time period being measured.

35. The system according to claim 19, wherein the code is further configured to output at least one benchmark so that each brand inside the competitor brand set is analyzed for their e weakness or the marketing performance metric in which they performed the least favorably, and marketing strategies and solutions are identified for the client to put into place to begin gaining traction against the competitors' brands.

36. The system according to claim 19, wherein the code is further configured to output at least one benchmark so that instructions are provided for how the client's brand can improve their performance in each of the nine marketing performance metrics.

37. A computer program product comprising a computer usable medium having a computer readable program code embodied therein, wherein the computer readable program code being constructed to be executed to implement a method of providing a brand benchmark of marketing performance for a client brand comprising:
defining an industry arena or vertical;
providing a client brand within the defined industry arena or vertical;
providing a group of competing brands within the defined industry arena or vertical;
providing brand keyword groups for the client brand and each competing brand to capture variations of the client brand name and variations of the competing brand names;
providing industry keyword groups to provide a sampling of discussions relating to the client brand and competing brands;
defining a plurality of marketing performance metrics;
extracting social media metrics from a plurality of social media sites using the brand keywords and industry keywords;
associating the social media metrics with the marketing performance metrics;
calculating benchmarks for each marketing performance metric for each brand, wherein a first marketing performance metric utilizing a first social media metric and a second marketing performance metric utilizing a second social media metric;
normalizing the marketing performance metrics so that the marketing performance metric benchmarks can relate to one another;
calculating an overall benchmark for each brand based on the marketing performance metric benchmarks; and
outputting at least one of the benchmarks.
